(19) United States
(12) Patent Application Publication
(10) Pub. No.: US 2010/0001637 A1
(43) Pub. Date: Jan. 7, 2010

(54) LIGHT-EMITTING ELEMENT, MULTICOLOR DISPLAY, AND METHOD FOR MANUFACTURING THE LIGHT-EMITTING ELEMENT

(75) Inventor: Tasuku SATOU, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/494,291

(22) Filed: Jun. 30, 2009

(30) Foreign Application Priority Data
Jul. 2, 2008 (JP) 2008-173863

(51) Int. Cl. H01J 1/62

(52) U.S. Cl. 313/504; 428/690

(57) ABSTRACT

The present invention provides a light-emitting element having, on a substrate, an organic electroluminescent part having at least one organic layer including a light-emitting layer between a pair of electrodes, and a color changing layer that absorbs light emitted from the organic electroluminescent part, and emits light having a wavelength different from that of the absorbed light, wherein the organic electroluminescent part and the color changing layer are disposed in a microcavity structure interposed between a light reflection layer and a layer that partially transmits light and partially reflects light. A light-emitting element of a color changing medium system having high color changing efficiency and high color purity is provided. A multicolor display using the same, and a method for manufacturing the light-emitting element are also provided.

### CROSS-REFERENCE TO RELATED APPLICATION

This application claims priority under 35 USC 119 from Japanese Patent Application No. 2008-173863, filed on Jul. 2, 2008, the disclosure of which is incorporated by reference herein.

### BACKGROUND OF THE INVENTION

1. Field of the Invention

The present invention relates to a light-emitting element that provides luminescence of high color purity, a multicolor display using the same, and a method for manufacturing the light-emitting element.

2. Description of the Related Art

Organic electroluminescent elements (hereinafter, referred to as “organic EL elements” in some cases) using a thin film material that is excited by applying electric current to emit light are known. Since the organic EL elements can provide light emission of high brightness at low voltage, the organic EL elements have broad potential applications in a wide range of fields including cellular-phone displays, personal digital assistants (PDAs), computer displays, car information displays, TV monitors, or general illumination, and have advantages in the respective fields, such as a reduced thickness, weight, and size and power saving. Therefore, the organic EL elements are greatly expected to play a leading role in the future electronic display market. However, in order to be practically used in place of conventional displays in these fields, there are many technical problems to be solved, such as with respect to light-emission brightness, color tone, durability under various ambient operation conditions, and mass productivity at low cost.

Multicolor displays using the organic EL elements are displays that have a plurality of elements arranged on a flat surface and give linear light emission or planar light emission. The number of the arranged light-emitting elements is not particularly limited and is determined to achieve light emission having a length or area required for the purpose and application. Generally, in the case of a small area display, at least 10×10 elements are two dimensionally arranged, in the case of a relatively large area display, at least 100×100 elements are two dimensionally arranged, and in the case of a large area display, at least 1000×1000 elements are two dimensionally arranged.

For example, FIG. 1 is a conceptual diagram illustrating an element arrangement of pixels in a display (D), wherein 12×12 light-emitting elements (Pixel: Px) (144 in total) are arranged on a flat surface. The region surrounded by the dashed line containing 100 light-emitting elements is an effective light emission region. When a size of one light-emitting element is 4 mm×4 mm, the area of the effective light emission region is about 100 mm×100 mm.

Efficient manufacturing of the display is also a major issue to be addressed in terms of practical use, and development of an element structure excellent in productivity attracts attentions from a technical viewpoint.

For example, a multicolor display is known in which light-emitting elements of three different light emission colors each emitting a red (R) light, a green (G) light, and a blue (B) light for multi-color representation are included by separately forming light-emitting layers corresponding to R, G, and B, respectively.

As another multicolor display, a system having a combination of a white light-emitting element and a color filter is known. In the system, light emission of each of RGB is taken out by combining each of RGB filters with a white light-emitting element.

As yet another multicolor display, a CCM (Color Changing Medium) system is known. The CCM system refers to a system in which a color changing medium (CCM) absorbs light emitted by the light-emitting element, and changes the absorbed light to light of another color having a longer wavelength than that of the absorbed light, to emit the changed light. For example, a G light can be taken out by combining a G changing CCM with a blue light-emitting element, and an R light can be taken out by combining an R changing CCM with a blue light-emitting element. A multicolor display can be assembled with these combinations.

Japanese Patent Application Laid-Open (JP-A) No. 2002-359076 and Japanese National Phase Publication No. 2002-520801 disclose a method using a microcavity (multiplex light-interference) as a method for improving color purity. The method is based on the following technique. When an organic EL element is interposed between a light reflection film and a half light transmission and half light reflection film, light emitted inside the element repeats reflection and undergoes resonance between the light reflection film and the half light transmission and half light reflection film. As a result, the wavelength of light to be taken out to the outside is limited by the distance (resonance length) between the light reflection film and the half light transmission and half light reflection film. Thus, light emission having a narrower spectral band width than that of an original light emission spectrum is taken out. In the microcavity structure, a desired wavelength can be taken out while being amplified by a combination of light emission in the cavity and a resonance length.

### SUMMARY OF THE INVENTION

In the manufacture of the multicolor display in which light-emitting elements of three different light emission colors for multi-color representation are included by separately forming light-emitting layers corresponding to R, G, and B, respectively, it is highly difficult to coat the layers addressed to RGB, and the larger the display size becomes, the more the alignment shifts due to a deflection or an expansion or contraction in a mask, and thus, a reduction in production yield becomes remarkable. In particular, in displays using a flexible substrate which are expected to be actively developed, not only the mask but also the substrate bends, or expands or contracts, which makes it more difficult to produce the same.

In the system having a combination of a white light-emitting element and a color filter, the amount of each light is reduced to about one third, since a white light is separated into three primary colors with the filter. Thus, in the system inevitably involves decreases in brightness and decreases in light emission efficiency.

In the CCM system, if the light changing by a color changing layer is achieved with high efficiency without loss, a G light-emitting element and an R light-emitting element each having an external quantum efficiency equivalent to that of a blue light element might theoretically be produced. However, in actually, it is difficult to design a CCM that absorbs about 100% of a blue light, and then changes 100% of the blue light to a green light or a red light. The blue light partially leaks without being absorbed at 100%, and thus, light of a blue light+a green light, or light of a blue light+a red light is obtained, which reduces the purity of the green light or the red light. Further, in order to increase the absorption of the blue light to reduce leakage thereof, a color changing layer needs to be thick. As a result, due to light scattering, pixels may become blurred to reduce definition. Still further, light emitted from the CCM has a wavelength distribution and is emitted as it is. Thus, it is difficult to obtain a sharp green color or red color, and the color purity decreases.

The method described in JP-A No. 2002-359076 and Japanese National Phase Publication No. 2002-520801 cannot amplify a wavelength that is not included in the light emitted from the light-emitting element. Accordingly, the method requires forming light-emitting layers corresponding to R, G, and B, respectively. Therefore, it has been difficult to use the microcavity structure for a large size screen or a flexible display as described above.

The present invention has been made in view of the above circumstances and provides a light-emitting element, a display using the same, and a method for manufacturing the light emitting element with the following aspects.

A first aspect of the invention provides a light-emitting element comprising, on a substrate:

an organic electroluminescent part having at least one organic layer including a light-emitting layer between a pair of electrodes; and

a color changing layer that absorbs light emitted from the organic electroluminescent part, and emits light having a wavelength different from that of the absorbed light;

wherein the organic electroluminescent part and the color changing layer are disposed in a microcavity structure interposed between a light reflection layer and a layer that partially transmits light and partially reflects light.

A second aspect of the invention provides a multicolor display, comprising a plurality of arranged light-emitting elements, wherein at least one of the light-emitting elements is the light-emitting element described in the first aspect.

A third aspect of the invention provides a method for manufacturing the light-emitting element described in the first aspect, comprising:

forming a light-emitting layer;

forming a color changing layer; and

forming a pair of a light reflection layer and a layer that partially transmits light and partially reflects light, between which both of the light-emitting layer and the color changing layer are interposed.

### BRIEF DESCRIPTION OF THE DRAWINGS

FIG. 1 is a conceptual diagram illustrating a planar arrangement of pixels in a multicolor display.

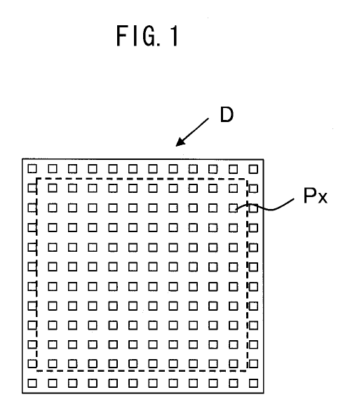

FIG. 2 is a schematic diagram illustrating a cross sectional view of a light-emitting element according to the present invention, in which A represents light that is subjected to color changing and taken out to the outside.

FIG. 3 is a schematic diagram illustrating a cross sectional view of a conventional color changing type light-emitting element, in which B represents a color changed light having a wide wavelength distribution, and C represents a leakage light.

FIG. 4 is a schematic diagram illustrating a cross sectional view of a multicolor display according to the present invention.

### DETAILED DESCRIPTION OF THE INVENTION

The present invention provides a light-emitting element capable of obtaining luminescence of high color purity, a multicolor display using the same, and a method for manufacturing the light-emitting element. Moreover, the present invention provides a multicolor display that has a common light-emitting element part is, and that can be simply produced, and a method for manufacturing the light-emitting element.

The invention provides a light-emitting element comprising, on a substrate, an organic electroluminescent part having at least one organic layer including a light-emitting layer between a pair of electrodes; and a color changing layer that absorbs light emitted from the organic electroluminescent part and emits light having a wavelength different from that of the absorbed light, wherein the organic electroluminescent part and the color changing layer are disposed in a microcavity structure interposed between a light reflection layer and a layer that partially transmits light and partially reflects light.

In embodiments, at least one of the light reflection layer and the layer that partially transmits light and partially reflects light forming the microcavity structure is one of the electrodes.

In embodiments, a light emission peak wavelength of the organic electroluminescent part is shorter than 500 nm.

In embodiments, a wavelength of light intensified in the normal direction of the substrate due to the microcavity structure is a wavelength of the light emitted from the color changing layer.

In embodiments, a light emitting material of the light-emitting layer is a phosphorescent light emitting material.

In embodiments, the substrate is a flexible substrate.

In embodiments, at least one of layers adjacent to the color changing layer is an insulating layer that does not absorb the light emitted from the organic electroluminescent part. In embodiments, a thickness of the insulating layer is from 5 nm to 30 nm.

A multicolor display of the present invention contains at least a plurality of arranged light-emitting elements, wherein at least one of the light-emitting elements is a light-emitting element having, on a substrate, at least an organic electroluminescent part having at least one organic layer including a light-emitting layer between a pair of electrodes; and a color changing layer that absorbs light emitted from the organic electroluminescent part and emits light having a wavelength different from that of the absorbed light, wherein the organic electroluminescent part and the color changing layer are disposed in a microcavity structure interposed between a light reflection layer and a layer that partially transmits light and partially reflects light.

In embodiments, the plurality of light-emitting elements are the same as each other in terms of the light emission peak wavelength of the organic electroluminescent part, a resonance distance of the microcavity structure of the light-emitting element having the color changing layer is adjusted based on a thickness of the color changing layer, and the resonance distance is adjusted to a wavelength resonating the light which has been changed by the color changing layer. In embodiments, a color filter is provided on the outside of the microcavity structure.

A method for manufacturing the light-emitting element of the present invention includes at least:

forming a light-emitting layer;

forming a color changing layer; and

forming a pair of a light reflection layer and a layer that partially transmits light and partially reflects light, between which both of the light-emitting layer and the color changing layer are interposed.

The present invention provides a light-emitting element capable of obtaining luminescence of high color purity, a multicolor display using the same, and a method for manufacturing the light-emitting element. Moreover, the present invention provides a multicolor display, in which a light-emitting element part has a common material and structure, and a changing material of a color changing layer and the thickness thereof are changed, whereby light having a desired wavelength is taken out while being resonated. According to the present invention, a light-emitting element, which provides luminescence of high color purity and is simply produced, a multicolor display using the same, and a method for manufacturing the light-emitting element are provided.

### 1. Structure of Light-Emitting Element

A light-emitting element of the invention is characterized in that it includes, on a substrate, an organic electroluminescent part (hereinafter, referred to as an “organic EL part” in some cases) having at least one organic layer containing a light-emitting layer (hereinafter, referred to as an “organic EL layer” in some cases) between a pair of electrodes, and a color changing layer that absorbs light emitted from the organic electroluminescent part and emits light having a wavelength different from that of the absorbed light, wherein the organic electroluminescent part and the color changing layer are disposed in a microcavity structure interposed between a light reflection layer and a layer that partially transmits light and partially reflects light.

More specifically, the light-emitting element of the invention solves the above-described former problems by disposing the color changing layer inside the microcavity structure. By disposing the color changing layer inside the microcavity structure, a blue light emitted from the organic EL element is repeatedly reflected within the cavity, and passes repeatedly through the color changing layer. Thus, even if the color changing layer is thin, the original blue light is fully absorbed, and color changing is performed with high changing efficiency. By designing a resonance distance so that a resonance wavelength of the microcavity corresponds to the peak wavelength of the light emitted from the color changing layer, the blue light from the organic EL element cannot leak in the front direction. More specifically, since the original blue light is absorbed in the color changing layer and changed to have a desired wavelength, emitted light with high color purity is taken out to the outside.

Preferably, at least one of the light reflection layer or the layer that partially transmits light and partially reflects light forming the microcavity structure is one of the electrodes. For example, the following structures are preferably used.
Substrate/light reflection layer/color changing layer/transparent electrode/organic EL layer/half light transmission and half light reflection electrode (emission from upper side)
Substrate/light reflection electrode/organic EL layer/transparent electrode/color changing layer/layer that partially transmits light and partially reflects light (emission from upper side)
Substrate/layer that partially transmits light and partially reflects light/color changing layer/transparent electrode/organic EL layer/light reflection electrode (emission from lower side)
Substrate/half light transmission and half light reflection electrode/organic EL layer/transparent electrode/color changing layer/light reflection layer (emission from lower side)

Preferably, the light emission peak wavelength of the organic EL part is shorter than 500 nm. More preferably, the light emitted from the organic EL part is a B light, and a G light and an R light are obtained by changing the B light by the color changing layer. More specifically, the organic EL part is common and two other colors can be formed by the color changing layer.

The multicolor display of the invention is a multicolor display in which a plurality of light-emitting elements is arranged.

Preferably, in the plurality of the light-emitting elements, the organic EL parts mutually have the same light emission peak wavelength, the resonance distance of the microcavity structure of the light-emitting element having the color changing layer is adjusted based on the thickness of the color changing layer, and the resonance distance is adjusted to a wavelength resonating the emitted light whose wavelength has been changed.

Preferably, a color filter is provided outside the microcavity structure. Preferably, the microcavity structure in the invention is designed so that the wavelength of light intensified in the normal direction of the substrate is the wavelength of the light emitted from the color changing layer. Thus, since light deviating from the normal direction is different in resonance wavelength, which reduces color purity, it is preferable to block such light by providing a color filter. Moreover, a structure of the invention in which the microcavity and a color filter are combined is preferable in that it is not necessary to form a polarizing plate, and thus, the structure is simplified.

The invention will be described in detail with reference to the drawings.

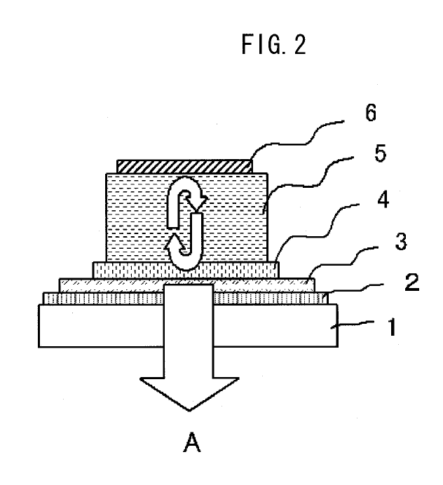

FIG. 2 is a schematic diagram illustrating a cross sectional view of a light-emitting element of the present invention. On a transparent substrate 1, a layer that partially transmits light and partially reflects light 2, a color changing layer 3, a transparent lower electrode 4, an organic layer 5 containing a light-emitting layer, and a light reflection upper electrode 6 are formed in this order. When voltage is applied between the electrodes, light of a first wavelength is emitted, and the emitted light is absorbed in the color changing layer 3. The light to be absorbed includes a direct incident light from a light emission part, and also light reflected by the light reflection upper electrode 6 and the layer that partially transmits light and partially reflects light 2. The light of the first wavelength repeats reflection until the light of the first wavelength is absorbed in the color changing layer 3. Thus, even when the color changing layer 3 is thin, the light of the first wavelength can be fully absorbed.

The color changing layer 3 absorbs the light of the first wavelength and emits light of a second wavelength that is a longer wavelength. For the color changing by the color changing layer, fluorescent luminescence is generally utilized. The obtained fluorescence has a broad spectrum distribution due to numerous energy levels of molecules. The distance between the light reflection upper electrode 6 and the layer that partially transmits light and partially reflects light 2 is designed to be an optical path length at which a desired wavelength component of second wavelength components resonates. Thus, only light having a desired wavelength is resonated, transmits through the layer that partially transmits light and partially reflects light 2, and is taken out to the outside. As a result, light A having high brightness, a narrow spectrum distribution, and high color purity is taken out.

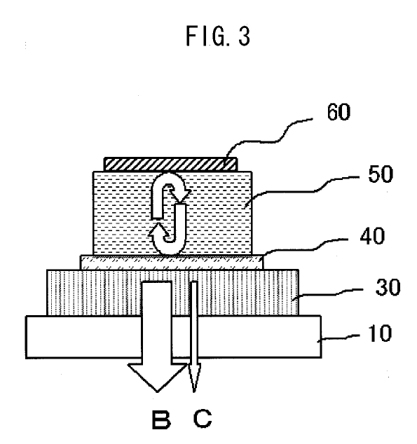

FIG. 3 is a schematic diagram illustrating a cross sectional view of a conventional light-emitting element having a color changing layer. On a transparent substrate 10, a color changing layer 30, a partial light transmission and partial light reflection electrode 40, an organic layer 50 containing a light-emitting layer, and a light reflection upper electrode 60 are disposed in this order. Light of a first wavelength emitted at the organic layer 50 repeats reflection between the partial light transmission and partial light reflection electrode 40 and the light reflection upper electrode 60. The resonated light transmits through the partial light transmission and partial light reflection electrode 40 to be absorbed in the color changing layer 30. The color changing layer 30 absorbs the light of the first wavelength, and emits light B of a second wavelength which is a longer wavelength. In the structure, the optical path length between the partial light transmission and partial light reflection electrode 40 and the light reflection upper electrode 60 must be designed to be a distance at which light to be absorbed in the color changing layer 30 resonates. The light B of the second wavelength emitted from the color changing layer 30 still has a broad spectrum distribution. Further, the light of the first wavelength is not completely absorbed in the color changing layer 30 and partially transmits without being absorbed (shown as Light C in FIG. 2). In order to increase absorptivity, the color changing layer 30 needs to be thick. Therefore, with respect to this structure, a spectrum distribution of the second wavelength of the light to be taken out is broad, and also the first wavelength component C is intermixed, resulting in a low brightness and a low color purity.

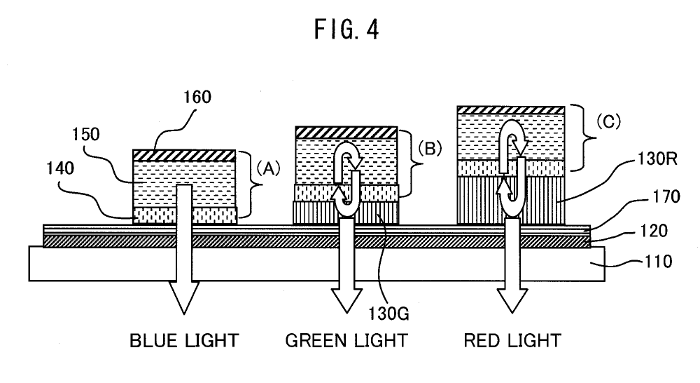

FIG. 4 is a schematic diagram illustrating a cross sectional view of a multicolor display according to the present invention, wherein a blue light-emitting element, a green light-emitting element, and a red light-emitting element are disposed. On a transparent substrate 110, a layer that partially transmits light and partially reflects light 120 and an insulating layer 170 are disposed in this order, and a green color changing layer 130G and a red color changing layer 130R are formed at portions where the green light-emitting element and the red light-emitting element are disposed, respectively. The organic EL part of the blue light-emitting element (A), the green light-emitting element (B), and the red light-emitting element (C) have a common configuration, which has a transparent lower electrode 140, an organic layer 150 containing a light-emitting layer, and a light reflection upper electrode 160, and emits a blue light. The resonance wavelength of the blue light-emitting element corresponds to a blue wavelength emitted by the organic EL part, the resonance wavelength of the green light-emitting element corresponds to a green light component in light emitted from the color changing layer, and the resonance wavelength of the red light-emitting element corresponds to a red light component in light emitted from the color changing layer. Therefore, according to the structure of the invention, the organic EL parts are common with each other, and therefore, color reproduction with high color purity and high brightness is achieved by simply disposing, in combination, color changing layers whose compositions and thicknesses are varied corresponding to desired colors. Method for Manufacturing Light-emitting element and Display of the invention Since a method for manufacturing a multicolor display of the invention does not need to form independently the organic electroluminescent part for each pixel in manufacturing, the number of manufacturing processes decreases, a production yield is improved, and cost reduction is can be expected. Moreover, various production processes can be applied to the method. Thus, even when a flexible substrate is used, a multicolor display is easily achieved. Instead of the necessity of forming independently the organic electroluminescent part for each pixel, it is necessary to form the color changing layer for each pixel. However, unlike the case of forming independently the light-emitting layer of the organic EL element for each pixel, various forming methods can be applied, and in addition, the number of the forming processes can be reduced.

In the structure of substrate/layer that partially transmits light and partially reflects light or light reflection layer/color changing layer/electrode 1/organic EL/light reflection electrode or half light transmission and half light reflection electrode, formation of the color changing layer is performed prior to formation of the element. Thus, the organic EL element is not affected at all. Also, even in the structure of substrate/light reflection electrode or half light transmission and half light reflection electrode/organic EL/transparent electrode/color changing layer/layer that partially transmits light and partially reflects light or light reflection layer, the color changing layer is at the outer side of the electrodes of the organic EL element. Thus, the element is hardly affected by formation of the color changing layer, and a degree of freedom with respect to techniques usable in the manufacturing becomes high.

Hereinafter, examples of the manufacturing method are to be described, but the invention is not limited thereto.

As a method for forming independently the color changing layer for each pixel in the invention, a laser transfer method, a laser removal method, a mask deposition method, or the like is acceptable. In all the methods, the number of manufacturing processes decreases, adverse effects to the light-emitting element are reduced, and a production yield can be improved, as compared with the case where the light-emitting layer is formed independently for each pixel by the same method to thereby achieve a multicolor display.

For example, when a light-emitting layer of a conventional element is formed by laser transfer, it is required to form independently the light-emitting layers for all RGB pixels by transfer. Thus, in many cases, laser radiation to another layer during transfer causes adverse affects, or the light-emitting element is adversely affected by the atmosphere during transfer, because layers for the light-emitting element are formed each independently inside the light emitting element. In contrast, in the case of formation of the color changing layer by transfer, only a green changing layer and a red changing layer are to be transferred, and thus, a fewer number of transfers is required. In addition, the organic electroluminescent part is hardly affected by a laser or the atmosphere.

In the case of conventional formation of the light-emitting layer by a laser removal method, the possibility that layers other than the light-emitting layer are removed by a laser is high. Thus, it is difficult to form the light-emitting layer by this method. In contrast, in the case of forming of the color changing layer by a laser removal method, the color changing layer of each pixel can be formed by, for example, vapor-depositing a red changing layer on the entire surface of the substrate, and thereafter removing the color changing layer at portions corresponding to green pixels and blue pixels, and then vapor-depositing a green changing layer on the entire surface, and thereafter removing portions corresponding to blue pixel portions by laser radiation. Although a red pixel portion contains a laminated color changing layer having the red changing layer and the green changing layer, this causes no problems. This is because light emitted from the green changing layer is further changed into a red color. When the transparent electrode, the organic EL part, and the upper electrode are formed after forming the color changing layer, a multicolor display can be easily achieved.

Even in the case of independent formation by the mask deposition method which is most common, the manufacturing method of the invention is effective. When the light-emitting layer of the organic EL element is independently formed by a mask deposition method in a conventional embodiment, layers of all RGB pixels need to be formed by the independent formation. Moreover, an element may be damaged due to contact with the mask or a short circuit may occur between an upper electrode and a lower electrode due to waste generated during transportation of the mask, resulting in a reduced production yield. In contrast, in the case where the color changing layer is formed by a mask deposition method, only a green changing layer and a red changing layer need to be formed independently, which reduces the number of layers to be formed independently. In addition, since an independent formation by a mask deposition method is performed before or after the formation of a light-emitting element film, the element is hardly adversely affected due to contact with the mask. More specifically, when the independent formation is performed before the formation of a light-emitting element film, the element is not damaged at all by the mask. Even when the independent formation is performed after the formation of the element film, the mask contacts with an upper surface of an electrode of the element, which further reduces adverse effects, as compared with the case of contact with the inside of the element. Moreover, the independent formation can be performed after the electrode is protected by a protective layer. Since it is not necessary to be concerned about contact with the mask, film formation can be performed by bringing the mask firmly into close contact with the substrate with an electromagnet, which makes it easy to avoid shifting due to expansion or contraction of the substrate or deflection of the mask.

### 2. Resonance Structure

The resonance structure in the invention is structured so that an organic EL part and a color changing layer are interposed between a pair of a light reflection layer and a layer that partially transmits light and partially reflects light, and the optical film thickness of the organic EL part and the optical film thickness of the layer that partially transmits light and partially reflects light are adjusted so as to obtain an optical path length at which an emission light that has been changed by the color changing layer resonates. Light with high color purity that has been intensified by resonance transmits through the layer that partially transmits light and partially reflects light to be taken out to the outside.

At least one of the upper electrode or the lower electrode of the organic EL part is a light reflection layer or a layer that partially transmits light and partially reflects light.

Preferably, the layer that partially transmits light and partially reflects light has a light transmittance of from 5% to 50%, and a light reflectance of from 50% to 90%.

Preferably, a material which forms the layer that partially transmits light and partially reflects light is a metal material. The metal material is preferably selected from the group consisting of platinum, gold, silver, chromium, tungsten, aluminum, magnesium, calcium, and sodium, or an alloy thereof.

Preferably, a thickness of the layer that partially transmits light and partially reflects light is from 5 nm to 50 nm. As a method of designing the resonance structure, known methods can be applied. For example, JP-A Nos. 06-283271, 07-282981, and 09-180883; J. Appl. Phys., Vol. 86, No. 5, 1 September 1999, pages 2407-2411, by Tokito et al.; Appl. Phys. Lett. (5), 2 Aug. 1993, pages 594-595, by Nakayama, et al.; Appl. Phys. Lett. 63 (15), 11 October 1993, pages 2032-2034, by Takada et al.; and the like describe methods for adjusting the resonance structure. The invention may use any of the methods.

### 3. Color Changing Layer

A color changing layer absorbs light emitted from the organic EL part, changes the wavelength, and emits light having a longer typical crystalline matrix include aluminum oxides, silicon oxides, phosphoric acid, and halophosphoric acid substituted by an alkaline earth metal, such as (X)₃Al₆O₂₇, (X)₄Al₄O₂₅, (X)₃A₁₂Si₂O₁₀, (X)₄Si₂O₈, (X)₂Si₂O₆, (X)₂P₂O₇, (X)₂P₂O₅, (X)₅(PO₄)₃Cl, (X)₂Si₃O₈, or (X)Cl₁₂ [herein, X represents an alkaline earth metal. The alkaline earth metal represented by X may be a single component or a mixed component of two or more of them. The mixing ratio thereof may be suitably determined.].

Examples of another preferable crystalline matrix include zinc oxides, zinc sulfides, oxides of rare earth metals, such as yttrium, gadolinium, lanthanum and the like, substances (sulfides) in which oxygen of the oxides is partially replaced with a sulfur atom, sulfides of rare earth metals, and substances obtained by blending an arbitrary metal element in the oxides or sulfides, and the like.

Preferable examples of the crystalline matrix are mentioned below: Mg₄GeO₅.5F, Mg₄GeO₆, ZnS, Y₂O₂S, Y₃Al₅O₁₂, Y₂SiO₁₀, Zn₂SiO₄, Y₂O₃, BaMgAl₁₀O₁₇, BaAl₁₂O₁₉, (Ba, Sr, Mg)O.aAl₂O₃, (Y, Gd) BO₃, (Zn, Cd)S, SrGa₂S₄, SrS, GaS, SnO₂, Ca₁₀(PO₄)₆(F, Cl)₂, (Ba, Sr)(Mg,Mn)Al₁₀O₁₇, (Sr, Ca, Ba, Mg)₁₀(PO₄)₆C₁₂, (La, Ce)PO₄, CeMgAl₁₁O₁₉, GdMgB₅O₁₀, Sr₂P₂O₇, Sr₄Al₁₄O₂₅, Y₂SO₄, Gd₂O₂S, Gd₂O₃, YVO₄, Y(P, V)O₄, and the like.

The crystalline matrix and activator or co-activator described above may be partially replaced with related elements, are not particularly limited in the element composition, and may absorb light of a purple-blue region to emit a visible light. wavelength. Specifically, a fluorescent dye can be used as a color changing material.

The fluorescent dye may be an organic phosphor or an inorganic phosphor and can be properly used according to a desired wavelength.

Examples of the organic phosphor include a coumarin pigment, a pyrane pigment, a cyanine pigment, a croconium pigment, a squarylium pigment, an oxobenzanthracene pigment, a fluoresceine pigment, a rhodamine pigment, a pyrylium pigment, a perylene pigment, a stilbene pigment, and a polythiophene pigment.

As the inorganic phosphor, a fine particle phosphor having a particle diameter of 3 μm or lower is preferable. An ultra-fine particle phosphor similar to a monodispersed dispersion synthesized via a liquid phase process is more preferable.

Examples of the inorganic phosphor include: an inorganic phosphor formed of a crystalline matrix and an activator; and a rare earth complex phosphor.

The composition of the inorganic phosphor is not particularly limited, and substances obtained by combining, a metal oxide typified by Y₂O₂S, Zn₂SiO₄, Ca₅(PO₄)₃Cl or the like, or a metal sulfide typified by ZnS, SrS, CaS or the like as a crystalline matrix, with a rare earth metal ion, such as Ce, Pr, Nd, Pm, Sm, Eu, Gd, Tb, Dy, Ho, Er, Tm, Yb or the like, or a metal ion, such as Ag, Al, Mn, In, Cu, Sb or the like as an activator or a co-activator are preferable.

The crystalline matrix is to be described in more detail. As the crystalline matrix, metal oxides are preferable. Examples of a

In the invention, preferable examples of the activator or co-activator for the inorganic phosphor include ions of lanthanoids typified by La, Eu, Tb, Ce, Yb, Pr and the like, and metal ions, such as Ag, Mn, Cu, In, Al and the like. The doping amount thereof is preferably from 0.001 mol % to 100 mol % and more preferably from 0.01 mol % to 50 mol % with respect to the matrix.

The activator or co-activator is doped in the crystal by partially replacing ions which form the crystalline matrix with ions of the lanthanoids described above.

The actual composition of the phosphor crystal is represented by the composition formula described below, when it is strictly described. Since the amount of the activator does not affect essential fluorescence characteristics in many cases, the numerical value of the following x or y is not indicated unless otherwise specified. For example, Sr₄₋ₓAl₁₄O₂₅:Eu²⁺ₓ is indicated as Sr₄Al₁₄O₂₅:Eu²⁺ in the invention.

Hereinafter, the composition formulae of typical inorganic phosphors (inorganic phosphors formed of crystalline matrix and activator) are mentioned below, but the invention is not limited thereto: (Ba_{z}Mg_{1-z})_{3-x-y}Al₁₆O₂₇: Eu²⁺ₓ, Mn²⁺, Sr⁴⁻ₓAl₁₄O₂₅:Eu²⁺ₓ, (Sr_{1-z}Ba_{z})₁₋ₓA₁₂Si₂O₈: Eu²⁺ₓ, Ba₂₋ₓSiO₄:Eu²⁺ₓ, Sr²⁻ₓSiO₄: Eu²⁺ₓ, Mg²⁻ₓSiO₄: Eu2⁺ₓ, (BaSr)₁₋ₓSiO₄: EU ²⁺ₓ, Y²⁻_{x-y}SiO₅: Ce³⁺ₓ, Tb³⁺_{y}, Sr²⁻ₓP₂O₅: Eu²⁺ₓ, Sr²⁻ₓP₂O₇: Eu²⁺ₓ, (Ba_{y}Ca_{z}Mg_{1-y-z})⁵⁻ₓ(PO₄)₃Cl: EU²⁺ₓ, Sr²⁻ₓSi₃O⁸⁻₂SrC₁₂: EU²⁺ₓ [x, y, and z each represent an arbitrary number of 1 or lower.].

Hereinafter, the inorganic phosphors preferably used in the invention are mentioned, but the invention is not limited to the following compounds.

Inorganic phosphors for Blue light emission

(BL-1) Sr₂P₂O₇:Sn⁴⁺

(BL-2) Sr₄Al₁₄O₂₅:Eu²⁺

(BL-3) BaMgAl₁₀O₁₇:Eu²⁺

(BL-4) SrGa₂S₄:Ce³⁺

(BL-5) CaGa₂S₄:Ce³⁺

(BL-6) (Ba, Sr)(Mg, Mn)Al₁₀O₁₇:Eu²⁺

(BL-7) (Sr, Ca, Ba, Mg)₁₀(PO₄)₆Cl₂:Eu²⁺

(BL-8) BaAl₂SiO₈:Eu²⁺

(BL-9) Sr₂P₂O₇:Eu²⁺

(BL-10) Sr₅(PO₄)₃Cl:Eu²⁺

(BL-11) (Sr,Ca,Ba)₅(PO₄)₃Cl:Eu²⁺

(BL-12) BaMg₂Al₁₆O₂₇:Eu²⁺

(BL-13) (Ba,Ca)₅(PO₄)₃Cl:Eu²⁺

(BL-14) Ba₃MgSi₂O₈:Eu²⁺

(BL-15) Sr₃MgSi₂O₈:Eu²⁺

Inorganic phosphors for Green light emission

(GL-1) (BaMg)Al₁₆O₂₇:Eu²⁺,Mn²⁺

(GL-2) Sr₄A1₁₄O₂₅:Eu²⁺

(GL-3) (SrBa)Al₂Si₂O₈:Eu²⁺

(GL-4) (BaMg)₂SiO₄:Eu²⁺

(GL-5) Y₂SiO₅:Ce³⁺,Tb³⁺

(GL-6) Sr₂P₂O₇—Sr₂B₂O₅:Eu²⁺

(GL-7) (BaCaMg)₅(PO₄)₃Cl:Eu²⁺

(GL-8) Sr₂Si₃O₈⁻²SrCl₂:Eu²⁺

(GL-9) Zr₂SiO₄, MgAl₁₁O₁₉:Ce³⁺,Tb³⁺

(GL-10) Ba₂SiO₄:Eu²⁺

(GL-11) Sr₂SiO₄:Eu²⁺

(GL-12) (BaSr)SiO₄:Eu²⁺

Inorganic phosphors for Red light emission

(RL-1) Y₂O₂S:Eu³⁺

(RL-2) YAlO₃:Eu³⁺

(RL-3) Ca₂Y₂(SiO₄)₆:Eu³⁺

(RL-4) LiY₉(SiO₄)₆O₂:Eu³⁺

(RL-5) YVO₄:Eu³⁺

(RL-6) CaS:Eu³⁺

(RL-7) Gd₂O₃:Eu³⁺

(RL-8) Gd₂O₂S:Eu³⁺

(RL-9) Y(P,V)O₄:Eu³⁺

(RL-10) Mg₄GeO_{5.5}F:Mn⁴⁺

(RL-11) Mg₄GeO₆:Mn⁴⁺

(RL-12) K₅Eu_{2.5}(WO₄)_{6.25}

(RL-13) Na₅Eu_{2.5}(WO₄)_{6.25}

(RL-14) K₅Eu_{2.5}(MoO₄)_{6.25}

(RL-15) Na₅Eu_{2.5}(MoO₄)_{6.25}

The inorganic phosphors may be subjected to surface modification treatment as required. Examples of a method for the surface modification treatment include chemical treatment using a silane coupling agent or the like, physical treatment by addition of fine particles of submicron order or the like, and a combined use thereof.

Examples of a rare earth complex phosphor include a phosphor containing, as a rare earth metal, Ce, Pr, Nd, Pm, Sm, Eu, Gd, Tb, Dy, Ho, Er, Tm, or Yb. As an organic ligand forming the complex, an aromatic organic ligand or a non-aromatic organic ligand may be acceptable, and compounds represented by Formula (B) are preferable.

Xa-(Lx)-(Ly)n-(Lz)-Ya, Formula (B):

In Formula (B), Lx, Ly, and Lz each independently represent an atom having two or more bonding partners, n represents 0 or 1, Xa represents a substituent having an atom capable of coordinating to an adjacent position of Lx, and Ya represents a substituent having an atom capable of coordinating to an adjacent position of Lz. An arbitrary portion of Xa and Lx may be condensed to each other to form a ring, an arbitrary portion of Ya and Lz may be condensed to each other to form a ring, Lx and Lz may be condensed to each other to form a ring, and at least one aromatic hydrocarbon ring or aromatic heterocycle exists in the molecule. However, no aromatic hydrocarbon ring or no aromatic heterocycle may exist when Xa-(Lx)-(Ly)n-(Lz)-Ya represents a β-diketone compound, a β-keto ester compound, a β-keto amide compound, substances in which the oxygen atom or the sulfur atom of the ketone is replaced with a sulfur atom or —N(R₂₀₁)—, crown ether, azacrown ether, thia crown ether, crown ether in which the oxygen atom of the crown ether is replaced with an arbitrary number of sulfur atoms or —N(R₂₀₁)—. In —N(R₂₀₁)—, R₂₀₁ represents a hydrogen atom, a substituted or unsubstituted alkyl group, or a substituted or unsubstituted aryl group.].

The atoms capable for coordination represented by Xa and Ya in Formula (B) are specifically an oxygen atom, a nitrogen atom, a sulfur atom, a selenium atom, or a tellurium atom, and are particularly preferably an oxygen atom, a nitrogen atom, or a sulfur atom.

In Formula (B), there is no particular limitation on the atom having two or more bonding partners represented by Lx, Ly, and Lz. Typically, a carbon atom, an oxygen atom, a nitrogen atom, a silicon atom, a titanium atom and the like are mentioned, and a carbon atom is preferable.

Specific examples of the rare earth complex phosphor represented by Formula (B) are mentioned below, but the invention is not limited thereto.

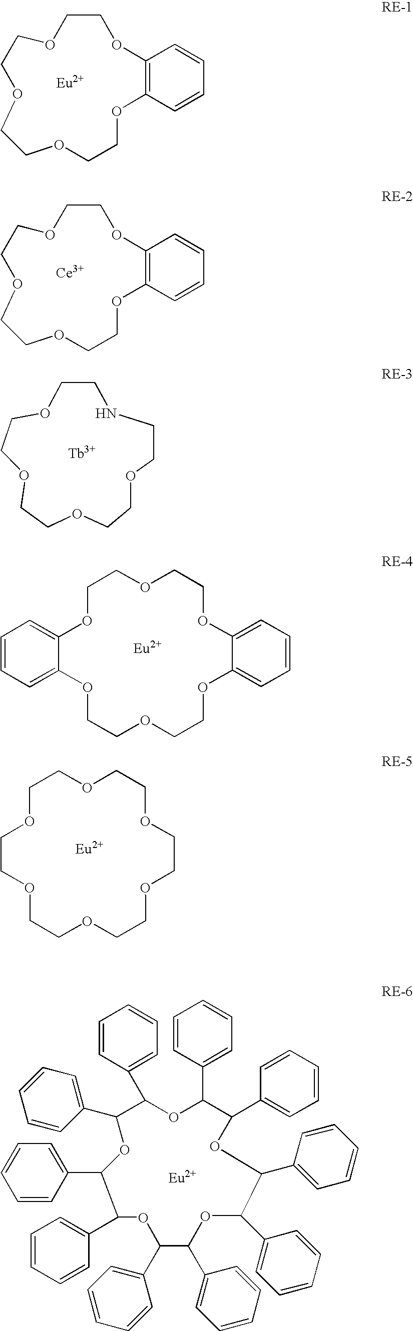

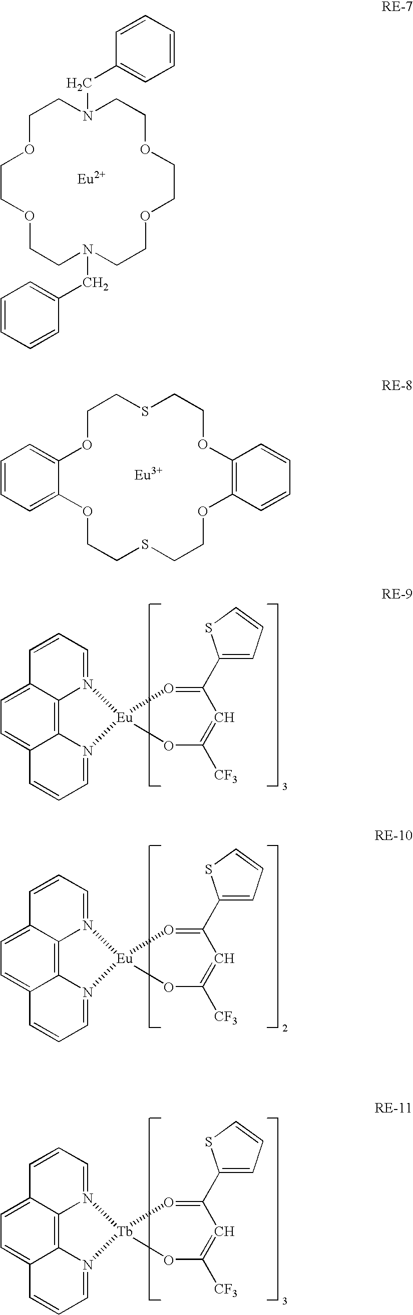

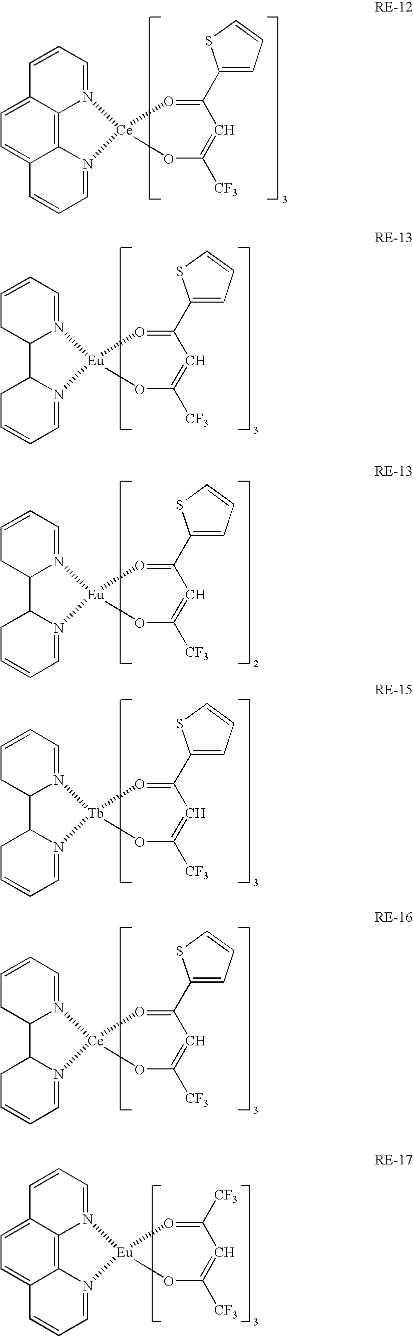

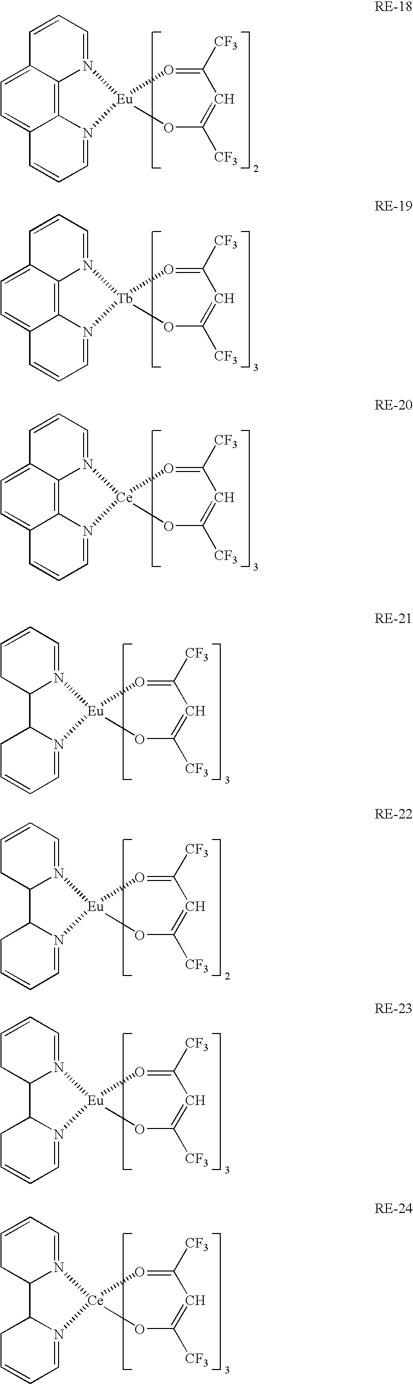

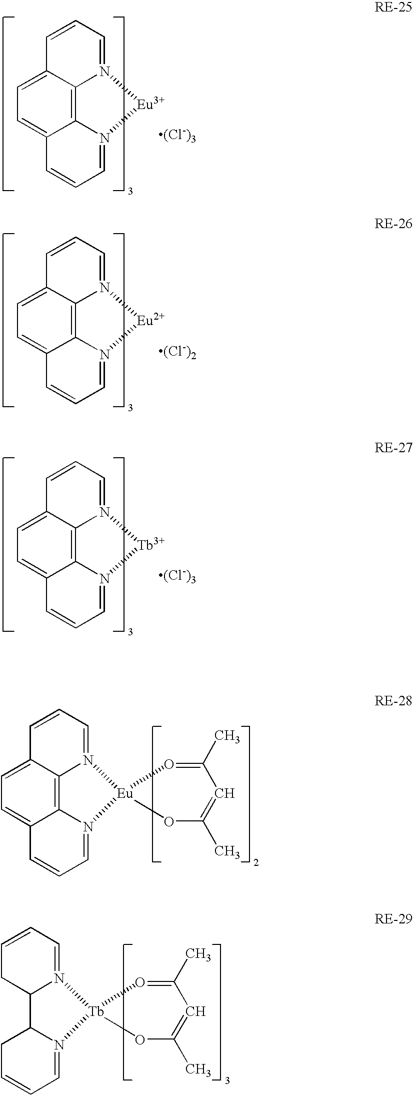

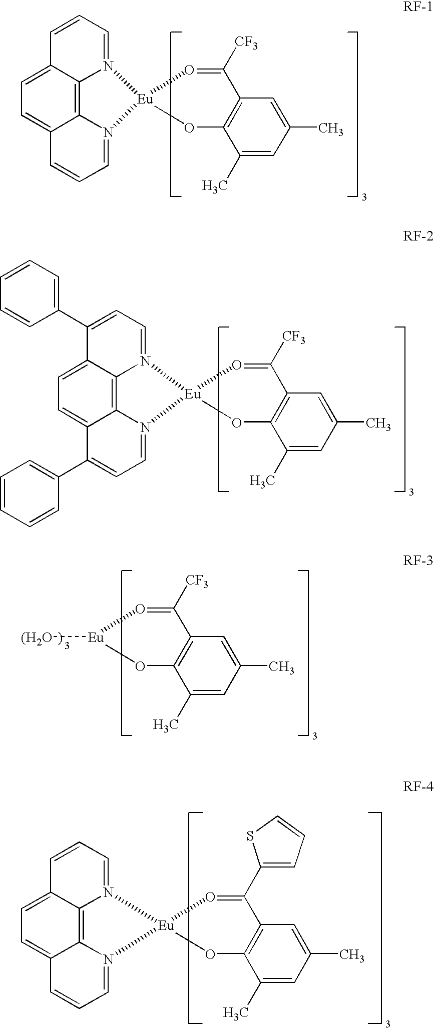

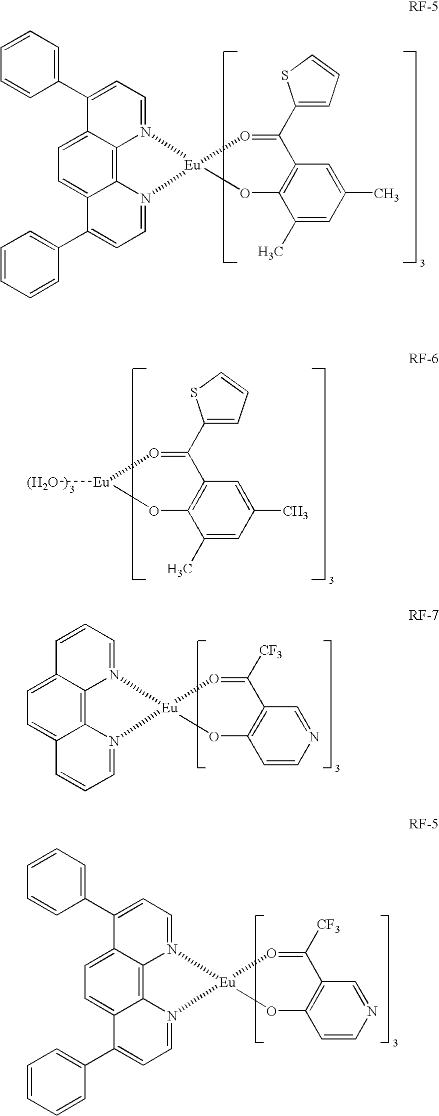

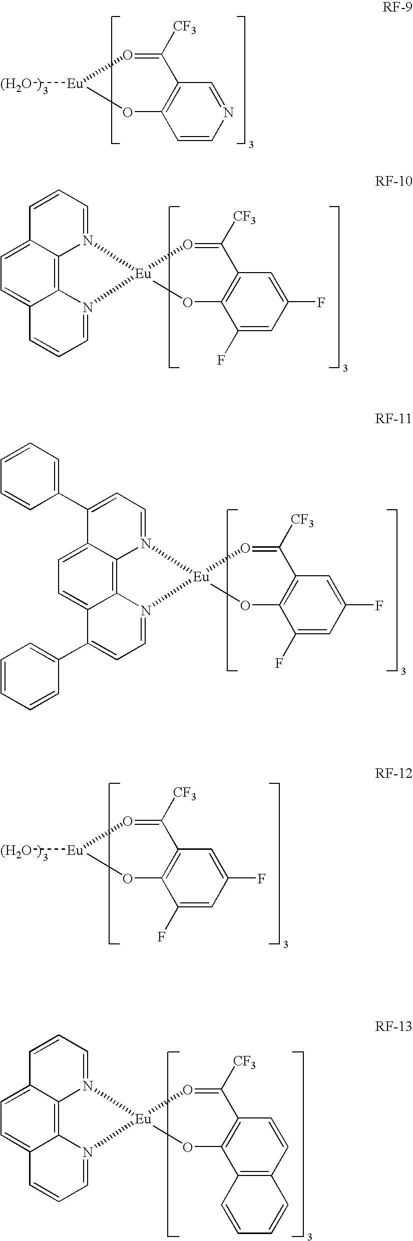

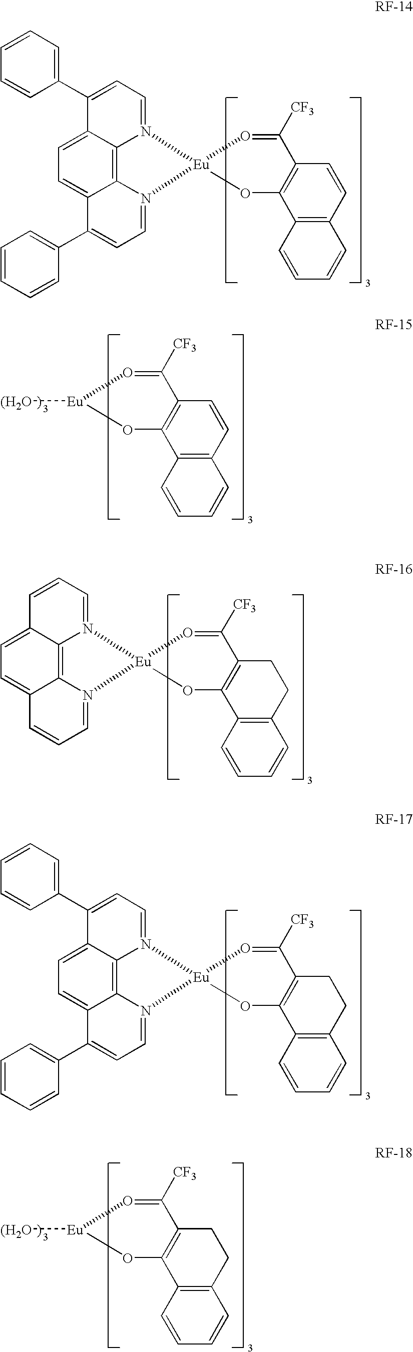

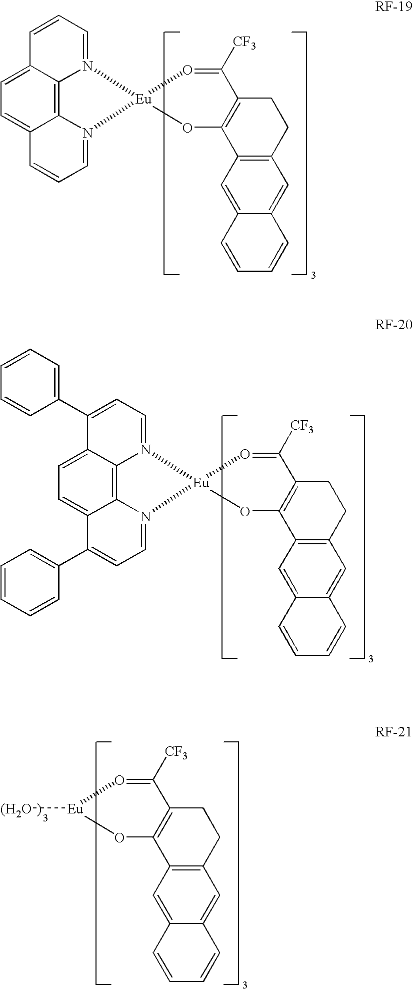

The color changing layer described above may have any form, such as a layer formed by depositing or sputtering the phosphor described above, or a coating layer in which the phosphor is dispersed in an appropriate resin as a binder. The film thickness is appropriately from about 5 nm to 50 μm. Herein, when formed into a coating layer in which the phosphor is dispersed in an appropriate resin as a binder, the dispersion concentration of the phosphor may be in the range where concentration quenching of fluorescence does not occur, and light emitted from the organic EL part can be fully absorbed. Depending on the type of phosphor, the dispersion concentration is appropriately about 10⁻⁷ mol to about 10⁻³ mol with respect to 1 g of resin to be used. In the case of the inorganic phosphor, the concentration quenching hardly poses a problem. Thus, the inorganic phosphor can be used in a range of about 0.1 g to 10 g with respect to 1 g of resin.

### 4. Organic EL Part

In the following, a configuration of the organic EL part employed in the present invention will be described in detail.

### Configuration/Order of Layer Lamination

In preferable embodiments, the organic compound layers (sometimes referred as “organic compound layers”) in the organic EL element of the present invention has plural emission units which are laminated, each of the emission units having one emission unit containing a hole transport layer, a light-emitting layer, and electron transport layer which are laminated in this order from the anode side. Moreover, a hole transporting intermediate layer may be provided between the hole transport layer and the light-emitting layer, and/or an electron transporting intermediate layer may be provided between the light-emitting layer and the electron transport layer. Further, a hole injection layer may be provided between the anode and the hole transport layer, and similarly, an electron injection layer may be provided in between the cathode and the electron transport layer. Preferably, an electrically insulating charge-generating layer is provided between the respective emission units.

At least one of the anode or the cathode in the present invention is formed on the light-extraction face and is half transmitting and half reflective to the light emitted in the light-emitting layer.

The reflectance and the transmittance of the half transmitting and reflective metal according to the present invention are determined by the following measuring methods.

### Apparatus for Measurement

A spectrophotometer that is commonly commercially available (for example, a U-4100 spectrophotometer manufactured by Hitachi Ltd.) is used.

### Measuring Method

Reflectance: a layer of a half transmitting and reflective metal is formed on a glass substrate, light for measurement is irradiated on the substrate at an incident angle of 5 degrees with respect to the normal direction of the substrate surface, and the reflected light therefrom at a reflection angle of −5 degrees is detected. The reflectance is expressed by Formula: reflectance=reflected light quantity÷incident light quantity.

Transmittance: light is irradiated on a sample similar to the above sample from the normal direction of the substrate surface (incident angle: 0 degrees), and the light outgoing in the normal direction (outgoing angle: 0 degrees) is detected. The transmittance is expressed by Formula: transmittance=outgoing light quantity÷incident light quantity.

According to the measuring method, the reflectance of the half transmitting and reflective metal in the present application is from 30% to 95%, preferably from 50% to 90%, at the maximum wavelength in the light-emission spectrum.

According to the measuring method, the transmittance of the half transmitting and reflective metal in the present application is from 5% to 70%, preferably from 10% to 50%, at the maximum wavelength in light-emission spectrum.

In preferable embodiments, the emission unit of the organic compound layers in the organic electroluminescent element of the present invention can have any one of the following configurations. (1) An emission unit having a hole injection layer, a hole transport layer (the hole injection layer may also serve as the hole transport layer), a hole transporting intermediate layer, a light-emitting layer, an electron transport layer, and an electron injection layer (the electron transport layer may also serve as a role of the electron injection layer) in this order from the anode side; (2) an emission unit having a hole injection layer, a hole transport layer (the hole injection layer may also serve as a role of the hole transport layer), a light-emitting layer, an electron transporting immediate layer, an electron transport layer, and an electron injection layer (the electron transport layer may also serve as the electron injection layer) in this order from the anode side; and (3) an emission unit having a hole injection layer, a hole transport layer (the hole injection layer may also serve as the hole transport layer), a hole transporting intermediate layer, a light-emitting layer, an electron transporting intermediate layer, an electron transport layer, and an electron injection layer (the electron transport layer may also serve as the electron injection layer) in this order from the anode side.

The above-described hole transporting intermediate layer preferably has at least one of a function for accelerating the injection of holes into the light-emitting layer, or a function for blocking electrons.

Furthermore, the above-described electron transporting intermediate layer preferably has at least one of a function for accelerating the injection of electrons into the light-emitting layer, or a function for blocking holes.

Moreover, at least one of the hole transporting intermediate layer or the electron transporting intermediate layer preferably has a function for blocking excitons produced in the light-emitting layer.

In order to effectively realize the functions for accelerating the injection of holes, or the injection of electrons, and the functions for blocking holes, electrons, or excitons, it is preferred that the hole transporting intermediate layer and the electron transporting intermediate layer are adjacent to the light-emitting layer.

The respective layers mentioned above may be divided into a plurality of secondary layers.

Next, the components which form the light-emitting element of the present invention will be described in detail.

### Formation of Organic Compound Layer

The respective layers which form the organic compound layers in the organic EL part employed in of the present invention can be suitably formed in accordance with any of: a dry film-forming method such as a vapor deposition method or a sputtering method; a transfer method; a printing method; a coating method; an ink-jet printing method; or a spray method.

### Hole Injection Layer and Hole Transport Layer

The hole injection layer and hole transport layer are layers which have a function for receiving holes from an anode or from an anode side and transporting the holes to a cathode side.

As an electron accepting dopant to be introduced into the hole injection layer or the hole transport layer, either of an inorganic compound or an organic compound may be used as long as the compound has electron accepting property and a function for oxidizing an organic compound. Specifically, Lewis acid compounds such as ferric chloride, aluminum chloride, gallium chloride, indium chloride, and antimony pentachloride are preferably used as the inorganic compounds.

In the case of applying an organic compound, compounds having a substituent such as a nitro group, a halogen atom, a cyano group, or a trifluoromethyl group; quinone compounds, acid anhydride compounds, and fullerenes may be preferably applied.

Specific examples of the organic compounds include hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, tetramethylbenzoquinone, 1,2,4,5-tetracyanobenzene, o-dicyanobenzene, p-dicyanobenzene, 1,4-dicyanotetrafluorobenzene, 2,3-dichloro-5,6-dicyanobenzoquinone, p-dinitrobenzene, m-dinitrobenzene, o-dinitrobenzene, p-cyanonitrobenzene, m-cyanonitrobenzene, o-cyanonitrobenzene, 1,4-naphthoquinone, 2,3-dichloronaphthoquinone, 1-nitronaphthalene, 2-nitronaphthalene, 1,3-dinitronaphthalene, 1,5-dinitronaphthalene, 9-cyanoanthracene, 9-nitroanthracene, 9,10-anthraquinone, 1,3,6,8-tetranitrocarbazole, 2,4,7-trinitro-9-fluorenone, 2,3,5,6-tetracyanopyridine, maleic anhydride, phthalic anhydride, fullerene C60, and fullerene C70.

Among these, hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthalene, 1,5-dinitronaphthalene, 9,10-anthraquinone, 1,3,6,8-tetranitrocarbazole, 2,4,7-trinitro-9-fluorenone, 2,3,5,6-tetracyanopyridine, or fullerene C60 is preferable. Hexacyanobutadiene, hexacyanobenzene, tetracyanoethylene, tetracyanoquinodimethane, tetrafluorotetracyanoquinodimethane, p-fluoranil, p-chloranil, p-bromanil, 2,6-dichlorobenzoquinone, 2,5-dichlorobenzoquinone, 2,3-dichloronaphthoquinone, 1,2,4,5-tetracyanobenzene, 2,3-dichloro-5,6-dicyanobenzoquinone, or 2,3,5,6-tetracyanopyridine is particularly preferred.

These electron accepting dopants may be used alone or in a combination of two or more of them.

Although an applied amount of these electron accepting dopants depends on the type of material, the applied amount of the dopant is preferably 0.01% by weight to 50% by weight, more preferably 0.05% by weight to 20% by weight, and particularly preferably 0.1% by weight to 10% by weight, with respect to an amount of a hole transport layer material. When the applied amount is less than 0.01% by weight with respect to the hole transport layer material, the effect of the present invention may not be sufficiently realized, and when it exceeds 50% by weight, hole transportability may be deteriorated.

As a material for the hole injection layer and the hole transport layer, it is preferred to contain specifically pyrrole compounds, carbazole compounds, pyrazole compounds, triazole compounds, oxazole compounds, oxadiazole compounds, imidazole compounds, polyarylalkane compounds, pyrazoline compounds, pyrazolone compounds, phenylenediamine compounds, arylamine compounds, amino-substituted chalcon compounds, styrylanthracene compounds, fluorenone compounds, hydrazone compounds, stilbene compounds, silazane compounds, aromatic tertiary amine compounds, styrylamine compounds, aromatic dimethylidine compounds, porphyrin compounds, organosilane compounds, carbon or the like.

Although a thickness of each of the hole injection layer and the hole transport layer is not particularly limited, it is preferred that the thickness is from 1 nm to 5 μm, it is more preferably from 5 nm to 1 μm, and 10 nm to 500 nm is particularly preferred in view of decrease in driving voltage, improvements in light-emission efficiency, and improvements in durability.

The hole injection layer or the hole transport layer may be composed of a monolayer structure containing at least one or two or more of the above-mentioned materials, or a multilayer structure composed of plural layers of a homogeneous composition or a heterogeneous composition.

When the carrier transport layer adjacent to the light-emitting layer is a hole transport layer, it is preferred that the Ip (HTL) of the hole transport layer is smaller than the Ip (D) of the dopant contained in the light-emitting layer in view of drive durability.

The Ip (HTL) in the hole transport layer may be measured in accordance with the below-mentioned measuring method of Ip.

A carrier mobility in the hole transport layer is usually from 10⁻⁷ cm²·V⁻¹·s⁻¹ to 10⁻¹ cm²·V⁻¹·s⁻¹; and within this range, from 10⁻⁵ cm²·V⁻¹·s⁻¹ to 10⁻¹ cm²·V⁻¹·s⁻¹ is preferable; from 10⁻⁴ cm²·V⁻¹·s⁻¹ to 10⁻¹ cm²·V⁻¹·s⁻¹ is more preferable; and from 10⁻³ cm²·V⁻¹·s⁻¹ to 10⁻¹ cm²·V⁻¹·s⁻¹ is particularly preferable in view of the light-emission efficiency.

For the carrier mobility, a value measured in accordance with a similar method to the method for measuring the carrier mobility in the light-emitting layer described below is adopted.

Moreover, it is preferred that the carrier mobility in the hole transport layer is higher than that in the light-emitting layer described below in view of drive durability and light-emission efficiency.

### Electron Injection Layer and Electron Transport Layer

The electron injection layer and the electron transport layer are layers having any of functions for injecting electrons from the cathode, transporting electrons, and becoming a barrier to holes which are injected from the anode.

An electron-donating dopant introduced into the electron injection layer or the electron transport layer, any material may be used as long as it has an electron-donating property and a property for reducing an organic compound, and alkaline metals such as Li, alkaline earth metals such as Mg, and transition metals including rare-earth metals are preferably used.

Particularly, metals having a work function of 4.2 V or less are preferably applied, and specific examples thereof include Li, Na, K, Be, Mg, Ca, Sr, Ba, Y, Cs, La, Sm, Gd, and Yb.

These electron-donating dopants may be used alone or in a combination of two or more of them.

An applied amount of the electron-donating dopants differs dependent on the types of the materials, but the amount is preferably from 0.1% by weight to 99% by weight, more preferably from 1.0% by weight to 80% by weight, and particularly preferably from 2.0% by weight to 70% by weight, with respect to an amount of an electron transport layer material. When the applied amount is less than 0.1% by weight, the efficiency of the present invention may not be sufficiently realized, and when it exceeds 99% by weight, the electron transportability may be deteriorated.

Specific examples of the materials applied for the electron injection layer and the electron transport layer include pyridine, pyrimidine, triazine, imidazole, triazole, oxazole, oxadiazole, fluorenone, anthraquinodimethane, anthrone, diphenylquinone, thiopyrandioxide, carbodiimide, fluorenylidenemethane, distyrylpyradine, fluorine-substituted aromatic compounds, aromacyclic tetracarboxylic anhydrides such as naphthalene or perylene, phthalocyanine, and modified compounds thereof (which may form a condensed ring with another ring); and a variety of metal complexes represented by metal complexes of 8-quinolinol compound, metal phthalocyanine, and metal complexes containing benzoxazole, or benzothiazole as the ligand.

Although a thickness of each of the electron injection layer and the electron transport layer is not particularly limited, it is preferred that the thickness is from 1 nm to 5 μm, more preferably from 5 nm to 1 μm, and particularly preferably from 10 nm to 500 nm in view of decrease in driving voltage, improvements in light-emission efficiency, and improvements in durability.

The electron injection layer or the electron transport layer may have either a monolayer structure containing at least one or two or more of the above-mentioned materials, or a multilayer structure composed of plural layers of a homogeneous composition or a heterogeneous composition.

When the carrier transport layer adjacent to the light-emitting layer is an electron transport layer, it is preferred that the Ea (ETL) of the electron transport layer is higher than the Ea (D) of the dopants contained in the light-emitting layer in view of drive durability.

For the Ea (ETL), a value measured in accordance with a similar method to the measuring method of Ea, which will be mentioned later, is used.

Furthermore, the carrier mobility in the electron transport layer is usually from 10⁻⁷ cm²·V⁻¹·s⁻¹ to 10⁻¹ cm²·V⁻¹·s⁻¹, and in this range from 10⁻⁵ cm²·V⁻¹·s⁻¹ to 10⁻¹ cm²·V⁻¹·s⁻¹ is preferable, from 10⁻⁴ cm²·V⁻¹·s⁻¹ to 10⁻¹ cm²·V⁻¹·s⁻¹ is more preferable, and from 10⁻³ cm²·V⁻¹·s⁻¹ to 10⁻¹ cm²·V⁻¹·s⁻¹ is particularly preferred, in view of light-emission efficiency.

Moreover, it is preferred that the carrier mobility in the electron transport layer is higher than that in the light-emitting layer in view of drive durability. The carrier mobility is measured in accordance with a similar method to that for the hole transport layer.

As to the carrier mobility of the light-emitting element of the present invention, it is preferred that the values of carrier mobility in the hole transport layer, the electron transport layer, and the light-emitting layer have the relationship of (electron transport layer≧hole transport layer)>light-emitting layer in view of drive durability.

As the host material contained in the buffer layer, the below-mentioned hole transporting host or electron transporting host may be preferably used.

### Light-Emitting Layer

Although the light-emitting layer in the present invention may contain plural light-emitting layers, a single light-emitting layer will be described herein. A combination of the plural light-emitting layers may be preferably selected from the configuration of monolayer explained hereinafter.

The light-emitting layer is a layer having a function for receiving holes from the anode, the hole injection layer, the hole transport layer or the hole transporting buffer layer, and receiving electrons from the cathode, the electron injection layer, the electron transport layer, or the electron transporting buffer layer, and for providing a place for recombination of the holes with the electrons to emit light.

The light-emitting layer of the present invention preferably contains at least a light-emitting dopant and a host compound.

The light-emitting layer may be composed of either one layer or two or more layers wherein the respective layers may emit light of different colors from one another in the respective layers. When the light-emitting layer is composed of a plurality thereof, it is preferred that each of the light-emitting layers contains at least a light-emitting dopant and a host compound.

It is preferred that a thickness of the light-emitting layer is generally 100 nm or less in order to lower the driving voltage, and more preferably from 5 nm to 100 nm.

The light-emitting dopant and the host compound contained in the light-emitting layer of the present invention may be either a combination of a fluorescent light-emitting dopant by which light emission (fluorescence) from a singlet exciton is obtained and the host compound, or a combination of a phosphorescent light-emitting dopant by which light emission (phosphorescence) from a triplet exciton is obtained and the host compound; among these, a combination of the phosphorescent light-emitting dopant and the host compound is preferable in view of light-emission efficiency.

The light-emitting layer of the present invention may contain two or more light-emitting dopants for improving color purity and expanding the wavelength region of emitted light.

### Light-Emitting Dopant

Any of phosphorescent light-emitting materials, fluorescent light-emitting materials and the like may be used as the light-emitting dopant in the present invention.

It is preferred that the light-emitting dopant in the present invention is one satisfying a relationship between the above-described host compound and the light-emitting dopant of 1.2 eV>ΔIp>0.2 eV and/or 1.2 eV>ΔEa>0.2 eV in view of drive durability.

### Phosphorescent Light-Emitting Dopant

Examples of the above-described phosphorescent light-emitting dopant generally include complexes containing a transition metal atom or a lanthanoid atom.

For instance, although the transition metal atom is not limited, it is preferably ruthenium, rhodium, palladium, tungsten, rhenium, osmium, iridium, or platinum; more preferably rhenium, iridium, or platinum; and even more preferably iridium or platinum.

Examples of the lanthanoid atom include lanthanum, cerium, praseodymium, neodymium, samarium, europium, gadolinium, terbium, dysprosium, holmium, erbium, thulium, ytterbium, and lutetium, and among these lanthanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU—(Organometallic Chemistry—Fundamental and Application—)” authored by Akio Yamamoto, published by Shokabo Publishing Co., Ltd. in 1982.

Specific examples of the ligands preferably include halogen ligands (preferably chlorine ligands), aromatic carbocyclic ligands (e.g., cyclopentadienyl anions, benzene anions, naphthyl anions and the like), nitrogen-containing heterocyclic ligands (e.g., phenylpyridine, benzoquinoline, quinolinol, bipyridyl, phenanthroline and the like), diketone ligands (e.g., acetylacetone and the like), carboxylic acid ligands (e.g., acetic acid ligands and the like), alcoholato ligands (e.g., phenolato ligands and the like), carbon monoxide ligands, isonitryl ligands, and cyano ligand, and more preferably nitrogen-containing heterocyclic ligands.

The above-described complexes may be either a complex containing one transition metal atom in the compound, or a so-called polynuclear complex containing two or more transition metal atoms wherein different metal atoms may be contained at the same time.

Among these, specific examples of the light-emitting dopants include phosphorescent light-emitting compounds described in patent documents such as U.S. Pat. No. 6,303,238B1, U.S. Pat. No. 6,097,147, International Patent Publication (WO) No. 00/57676, WO No. 00/70655, WO No. 01/08230, WO No. 01/39234A2, WO No. 01/41512A1, WO No. 02/02714A2, WO No. 02/15645A1, WO No. 02/44189A1, JP-A No. 2001-247859, Japanese Patent Application No. 2000-33561, JP-A Nos. 2002-117978, 2002-225352, and 2002-235076, Japanese Patent Application No. 2001-239281, JP-A No. 2002-170684, European Patent (EP) No. 1211257, JP-A Nos. 2002-226495, 2002-234894, 2001-247859, 2001-29.8470, 2002-173674, 2002-203678, 2002-203679, and 2004-357791, Japanese Patent Application Nos. 2005-75340 and 2005-75341, etc. Among these, more preferable examples of the light-emitting dopants include Ir complexes, Pt complexes, Cu complexes, Re complexes, W complexes, Rh complexes, Ru complexes, Pd complexes, Os complexes, Eu complexes, Tb complexes, Gd complexes, Dy complexes, and Ce complexes; particularly preferable are Ir complexes, Pt complexes, and Re complexes; and among these, Ir complexes, Pt complexes, and Re complexes each containing at least one coordination mode of metal-carbon bonds, metal-nitrogen bonds, metal-oxygen bonds, and metal-sulfur bonds are preferred.

### Fluorescent Light-Emitting Dopant

Examples of the above-described fluorescent light-emitting dopants generally include benzoxazole, benzoimidazole, benzothiazole, styrylbenzene, polyphenyl, diphenylbutadiene, tetraphenylbutadiene, naphthalimide, coumarin, pyran, perinone, oxadiazole, aldazine, pyralidine, cyclopentadiene, bis-styrylanthracene, quinacridone, pyrrolopyridine, thiadiazolopyridine, cyclopentadiene, styrylamine, aromatic dimethylidene compounds, condensed polyaromatic compounds (anthracene, phenanthroline, pyrene, perylene, rubrene, pentacene and the like), a variety of metal complexes represented by metal complexes of 8-quinolinol, pyromethene complexes or rare-earth complexes, polymers such as polythiophene, polyphenylene or polyphenylenevinylene, organic silanes, and modified compounds thereof.

Among these, specific examples of the light-emitting dopants include the following compounds, but it should be noted that the present invention is not limited thereto.

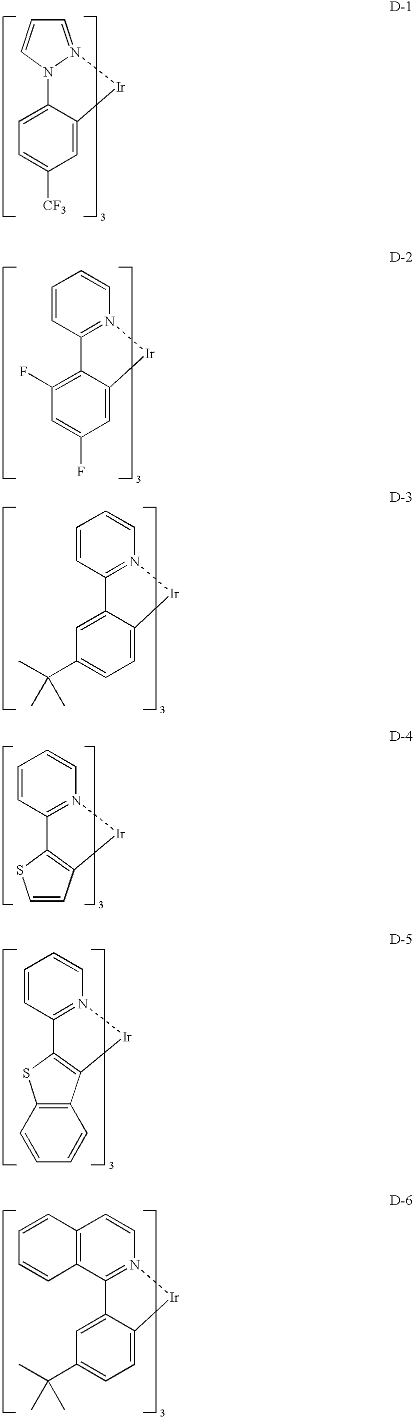

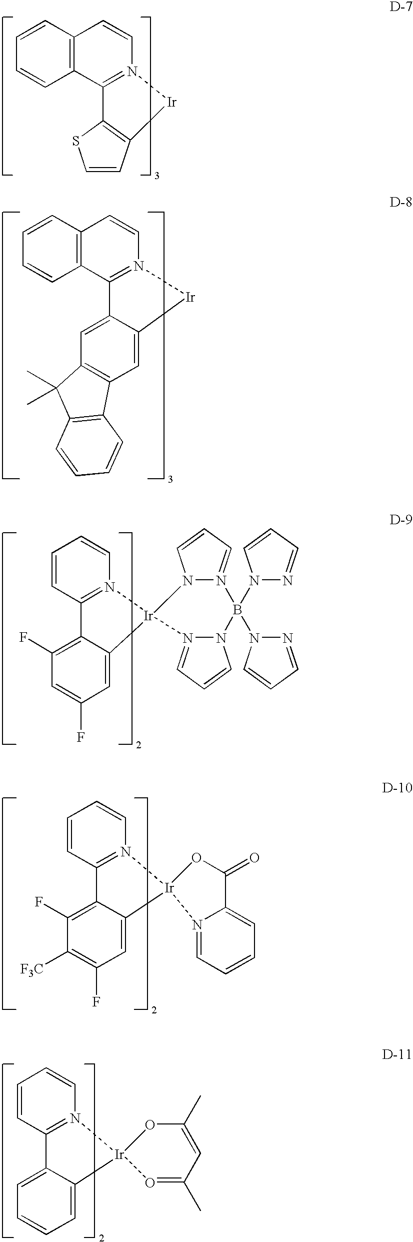

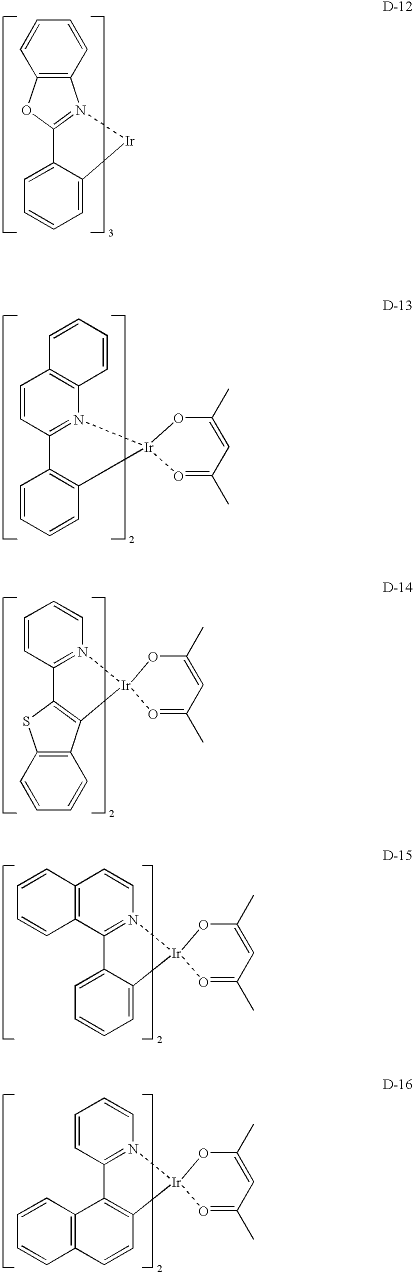

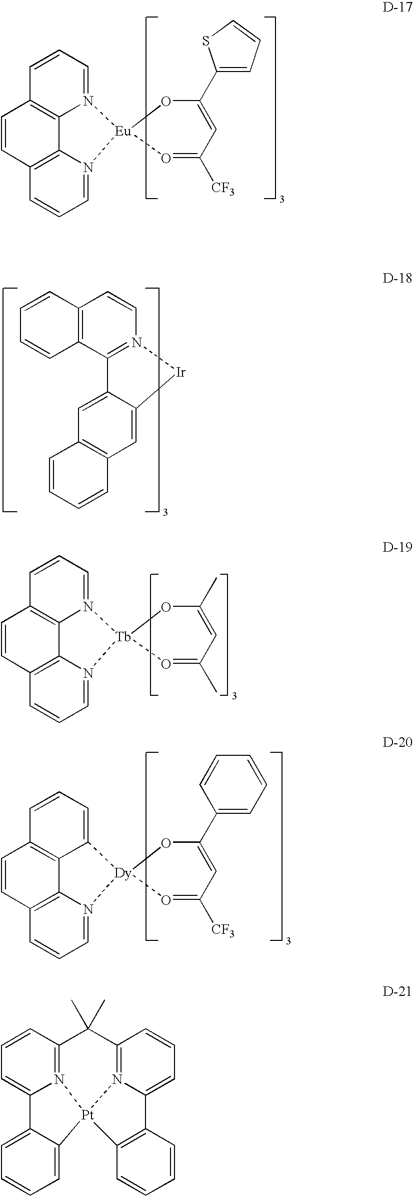

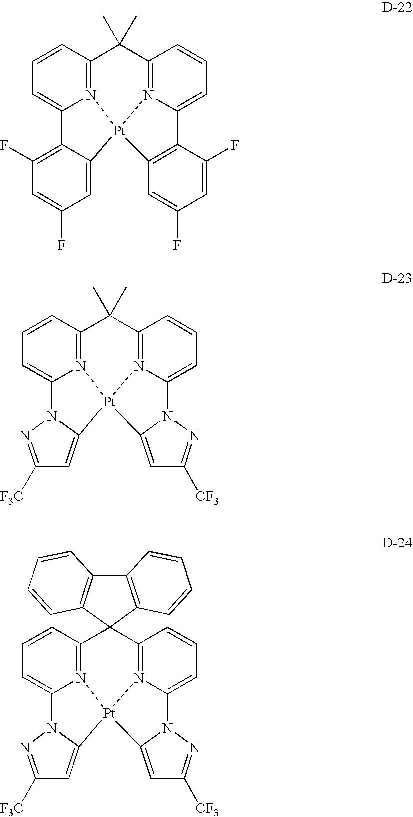

Among the above-described compounds, as the light-emitting dopants to be used in the present invention, D-2, D-3, D-4, D-5, D-6, D-7, D-8, D-9, D-10, D-11, D-12, D-13, D-14, D-15, D-16, D-21, D-22, D-23, or D-24 is preferable, D-2, D-3, D-4, D-5, D-6, D-7, D-8, D-12, D-14, D-15, D-16, D-21, D-22, D-23, or D-24 is more preferable, and D-21, D-22, D-23, or D-24 is even more preferable in view of light-emission efficiency and durability.

The light-emitting dopant in a light-emitting layer is generally contained in an amount of from 0.1% by weight to 30% by weight with respect to the total mass of the compounds forming the light-emitting layer, and it can be preferably contained in an amount of from 1% by weight to 15% by weight, and more preferably in an amount of from 2% by weight to 12% by weight in view of durability and light-emission efficiency.

Although a thickness of the light-emitting layer is not particularly limited, 1 nm to 500 nm is usually preferred, and 5 nm to 200 nm is more preferable, and 5 nm to 100 nm is even more preferred in view of light-emission efficiency.

### Host Material

As the host material to be used in the present invention, hole transporting host materials excellent in hole transporting property (referred to as a “hole transporting host” in some cases) and electron transporting host compounds excellent in electron transporting property (referred to as an “electron transporting host” in some cases) may be used.

### Hole Transporting Host

The hole transporting host used for the organic layer of the present invention preferably has an ionization potential Ip of 5.1 eV to 6.3 eV, more preferably has an ionization potential of 5.4 eV to 6.1 eV, and even more preferably has an ionization potential of 5.6 eV to 5.8 eV in view of improvements in durability and decrease in driving voltage. Furthermore, it preferably has an electron affinity Ea of 1.2 eV to 3.1 eV, more preferably of 1.4 eV to 3.0 eV, and even more preferably of 1.8 eV to 2.8 eV in view of improvements in durability and decrease in driving voltage.

Specific examples of such hole transporting hosts as mentioned above include pyrrole, carbazole, triazole, oxazole, oxadiazole, pyrazole, imidazole, polyarylalkane, pyrazoline, pyrazolone, phenylenediamine, arylamine, amino-substituted chalcone, styrylanthracene, fluorenone, hydrazone, stilbene, silazane, aromatic tertiary amine compounds, styrylamine compounds, aromatic dimethylidine compounds, porphyrin compounds, polysilane compounds, poly(N-vinylcarbazole), aniline copolymers, electrically conductive high-molecular oligomers such as thiophene oligomers, polythiophenes and the like, organic silanes, carbon films, modified compounds thereof, and the like.

Among these, carbazole compounds, aromatic tertiary amine compounds, and thiophene compounds are preferable, and particularly, compounds containing a plurality of carbazole skeletons and/or aromatic tertiary amine skeletons in the molecule are preferred.

As specific examples of the hole transporting hosts described above, the following compounds are listed, but the present invention is not limited thereto.

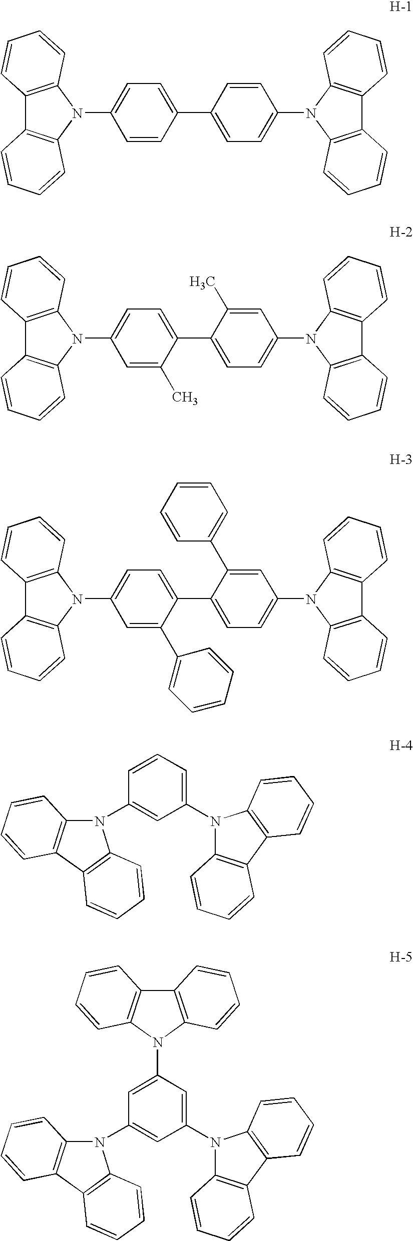

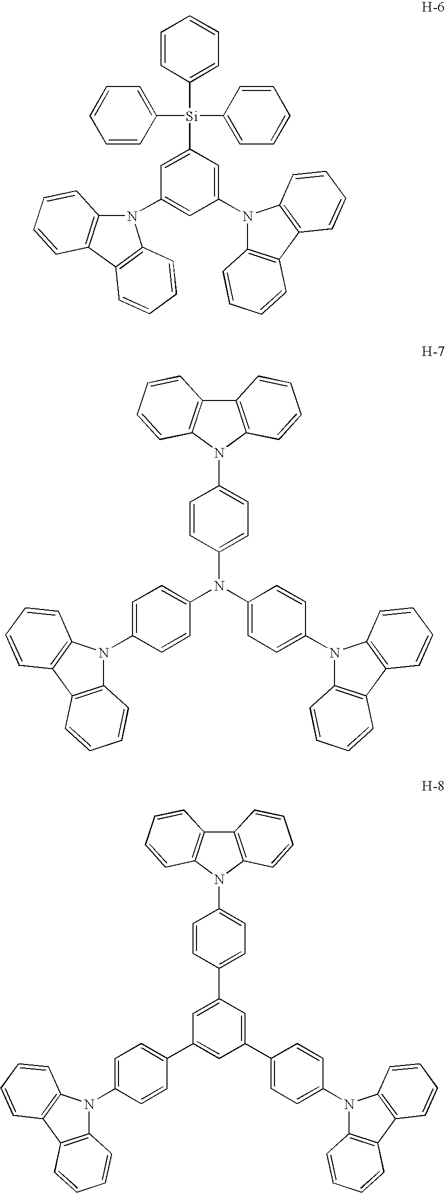

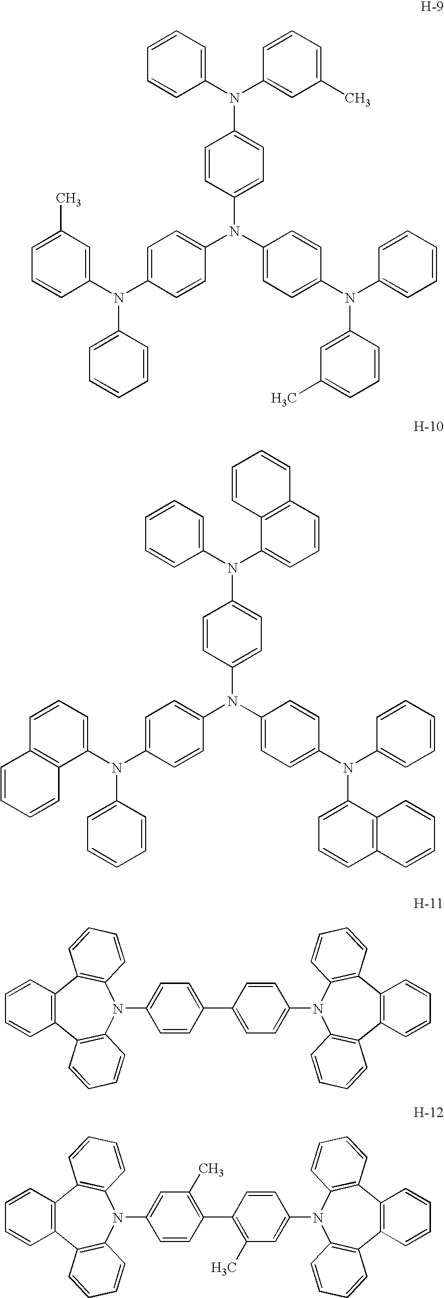

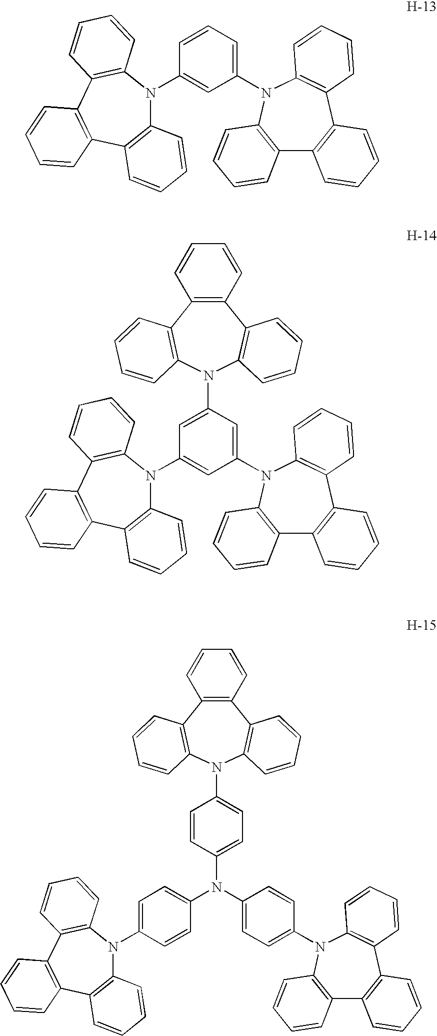

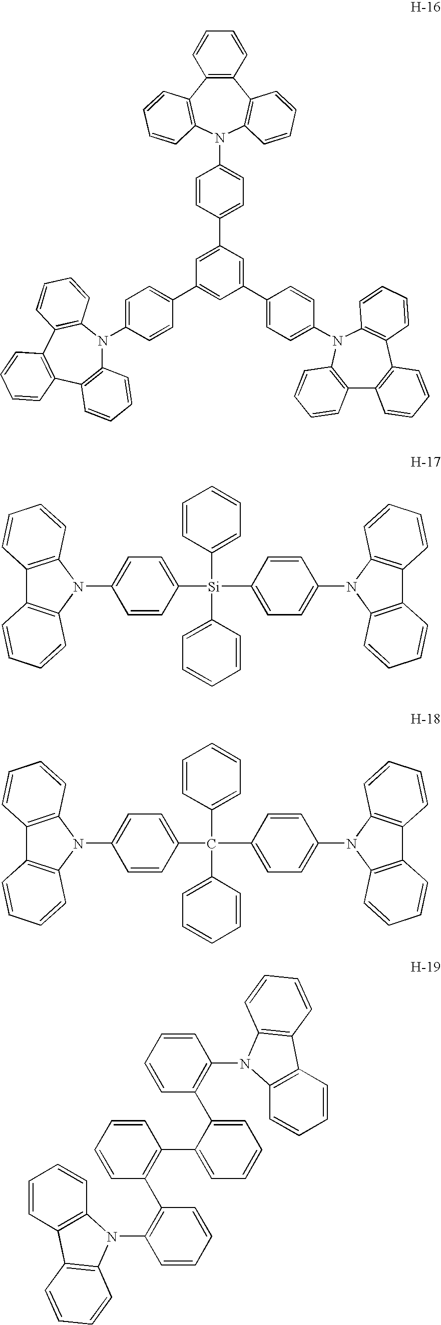

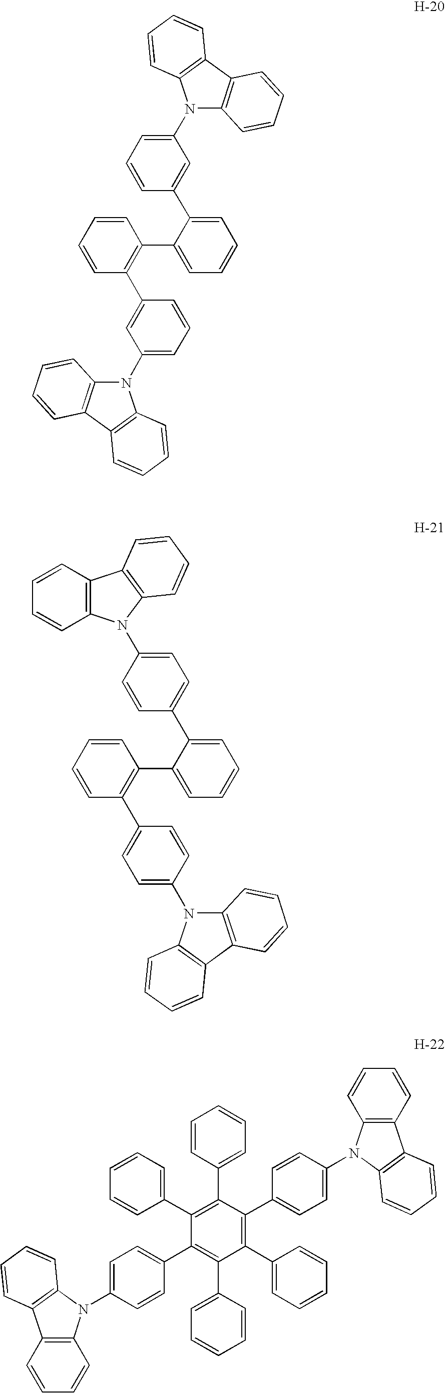

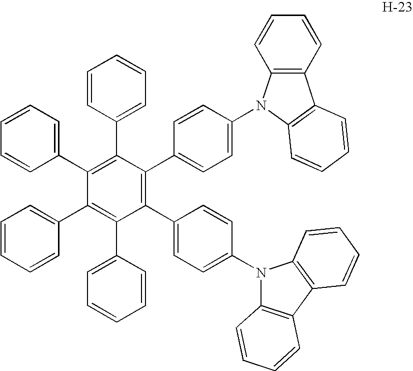

### Electron Transporting Host

As the electron transporting host used in the present invention, it is preferred that an electron affinity Ea of the host is from 2.5 eV to 3.5 eV, more preferably from 2.6 eV to 3.2 eV, and even more preferably from 2.8 eV to 3.1 eV in view of improvements in durability and decrease in driving voltage. Furthermore, it is preferred that an ionization potential Ip of the host is from 5.7 eV to 7.5 eV, more preferably from 5.8 eV to 7.0 eV, and even more preferably from 5.9 eV to 6.5 eV in view of improvements in durability and decrease in driving voltage.

Specific examples of such electron transporting hosts as mentioned above include pyridine, pyrimidine, triazine, imidazole, pyrazole, triazole, oxazole, oxadiazole, fluorenone, anthraquinodimethane, anthrone, diphenylquinone, thiopyrandioxide, carbodiimide, fluorenylidenemethane, distyrylpyrazine, fluorine-substituted aromatic compounds, tetracarboxylic anhydrides of aromatic ring compound such as naphthalene, perylene or the like, phthalocyanine, modified compounds thereof (which may form a condensed ring with another ring), and a variety of metal complexes represented by metal complexes of 8-quinolinol compound, metal phthalocyanine, and metal complexes having benzoxazole or benzothiazole as the ligand.

Preferable electron transporting hosts are metal complexes, azole compounds (benzimidazole compounds, imidazopyridine compounds and the like), and azine compounds (pyridine compounds, pyrimidine compounds, triazine compounds and the like). Among these, metal complexes are preferred in the present invention in view of durability. As the metal complex compound, a metal complex containing a ligand having at least one nitrogen atom, oxygen atom, or sulfur atom to be coordinated to the metal is more preferable.

Although the metal ion in the metal complex is not particularly limited, a beryllium ion, a magnesium ion, an aluminum ion, a gallium ion, a zinc ion, an indium ion, a tin ion, a platinum ion, or a palladium ion is preferred; more preferable is a beryllium ion, an aluminum ion, a gallium ion, a zinc ion, a platinum ion, or a palladium ion; and even more preferable is an aluminum ion, a zinc ion, or a palladium ion.

Although there are a variety of well-known ligands to be contained in the above-described metal complexes, examples thereof include ligands described in “Photochemistry and Photophysics of Coordination Compounds” authored by H. Yersin, published by Springer-Verlag Company in 1987; “YUHKI KINZOKU KAGAKU —KISO TO OUYOU—(Organometallic Chemistry—Fundamental and Application—)” authored by Akio Yamamoto, published by Shokabo Publishing Co., Ltd. in 1982, and the like.

The ligands are preferably nitrogen-containing heterocyclic ligands (having preferably 1 to 30 carbon atoms, more preferably 2 to 20 carbon atoms, and particularly preferably 3 to 15 carbon atoms); and they may be a unidentate ligand or a bi- or higher-dentate ligand. Preferable are bi- to hexa-dentate ligands, and mixed ligands of bi- to hexa-dentate ligands with a unidentate ligand are also preferable.

Examples of the ligands include azine ligands (e.g., pyridine ligands, bipyridyl ligands, terpyridine ligands and the like); hydroxyphenylazole ligands (e.g., hydroxyphenylbenzimidazole ligands, hydroxyphenylbenzoxazole ligands, hydroxyphenylimidazole ligands, hydroxyphenylimidazopyridine ligands and the like); alkoxy ligands (those having preferably 1 to 30 carbon atoms, more preferably 1 to 20 carbon atoms, and particularly preferably 1 to 10 carbon atoms, examples thereof include methoxy, ethoxy, butoxy, 2-ethylhexyloxy and the like); aryloxy ligands (those having preferably 6 to 30 carbon atoms, more preferably 6 to 20 carbon atoms, and particularly preferably 6 to 12 carbon atoms, examples thereof include phenyloxy, 1-naphthyloxy, 2-naphthyloxy, 2,4,6-trimethylphenyloxy, 4-biphenyloxy and the like);
heteroaryloxy ligands (those having preferably 1 to 30 carbon atoms, more preferably 1 to 20 carbon atoms, and particularly preferably 1 to 12 carbon atoms, examples of which include pyridyloxy, pyrazinyloxy, pyrimidyloxy, quinolyloxy and the like); alkylthio ligands (those having preferably 1 to 30 carbon atoms, more preferably 1 to 20 carbon atoms, and particularly preferably 1 to 12 carbon atoms, examples thereof include methylthio, ethylthio and the like); arylthio ligands (those having preferably 6 to 30 carbon atoms, more preferably 6 to 20 carbon atoms, and particularly preferably 6 to 12 carbon atoms, examples of which include phenylthio and the like); heteroarylthio ligands (those having preferably 1 to 30 carbon atoms, more preferably 1 to 20 carbon atoms, and particularly preferably I to 12 carbon atoms, examples of which include pyridylthio, 2-benzimidazolylthio, benzoxazolylthio, 2-benzothiazolylthio and the like); siloxy ligands (those having preferably 1 to 30 carbon atoms, more preferably 3 to 25 carbon atoms, and particularly preferably 6 to 20 carbon atoms, examples of which include a triphenylsiloxy group, a triethoxysiloxy group, a triisopropylsiloxy group and the like); aromatic hydrocarbon anion ligands (those having preferably 6 to 30 carbon atoms, more preferably 6 to 25 carbon atoms, and particularly preferably 6 to 20 carbon atoms, examples of which include a phenyl anion, a naphthyl anion, an anthranyl anion and the like); aromatic heterocyclic anion ligands (those having preferably 1 to 30 carbon atoms, more preferably 2 to 25 carbon atoms, and particularly preferably 2 to 20 carbon atoms, examples of which include a pyrrole anion, a pyrazole anion, a triazole anion, an oxazole anion, a benzoxazole anion, a thiazole anion, a benzothiazole anion, a thiophene anion, a benzothiophene anion and the like); indolenine anion ligands and the like. Among these, nitrogen-containing heterocyclic ligands, aryloxy ligands, heteroaryloxy groups, siloxy ligands, aromatic hydrocarbon anion ligands, and aromatic heterocyclic anion ligands are preferable, and nitrogen-containing heterocyclic ligands, aryloxy ligands, heteroaryloxy groups, and siloxy ligands are more preferable.

Examples of the metal complex electron transporting hosts include compounds described, for example, in JP-A Nos. 2002-235076, 2004-214179, 2004-221062, 2004-221065, 2004-221068, 2004-327313 and the like.

Specific examples of these electron transporting hosts include the following materials, but it should be noted that the present invention is not limited thereto.

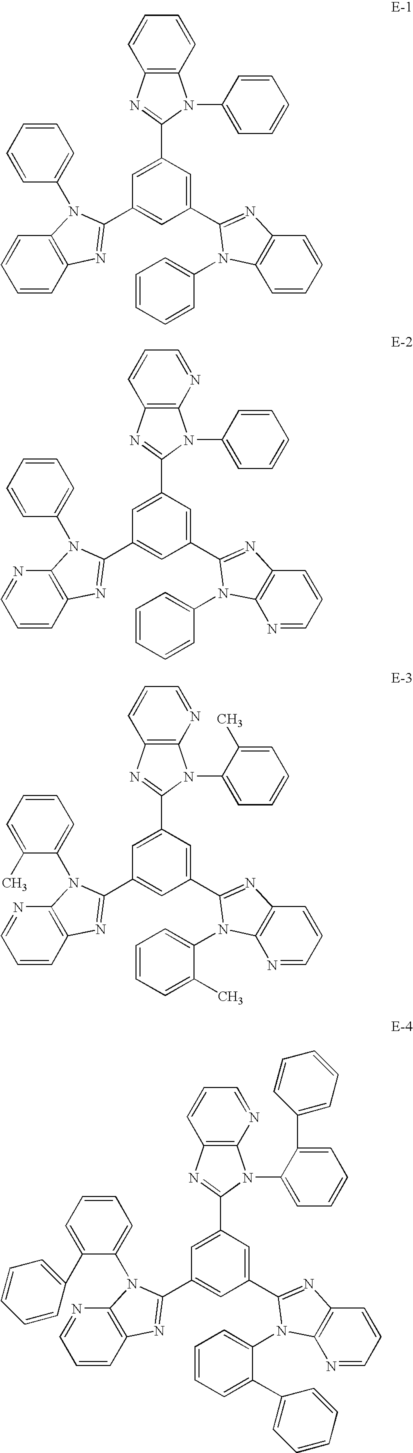

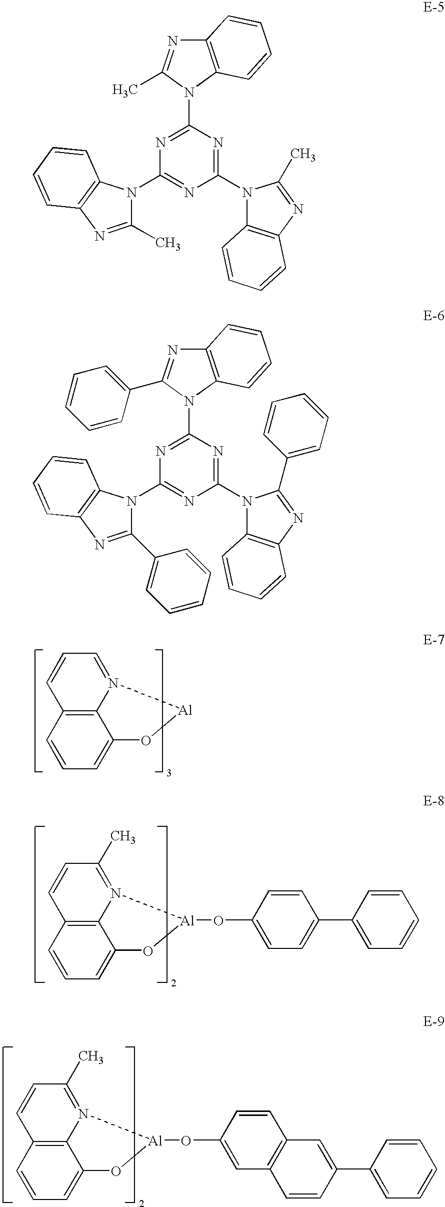

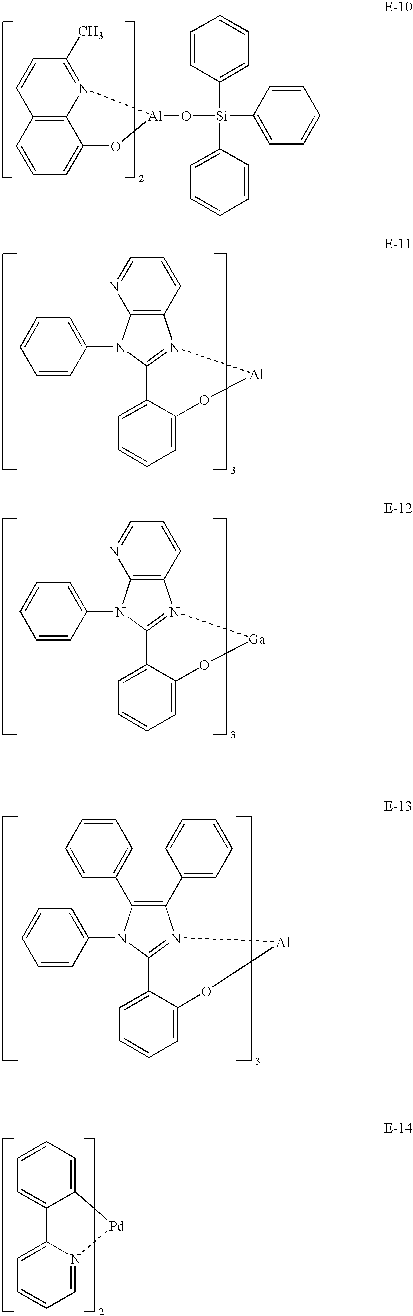

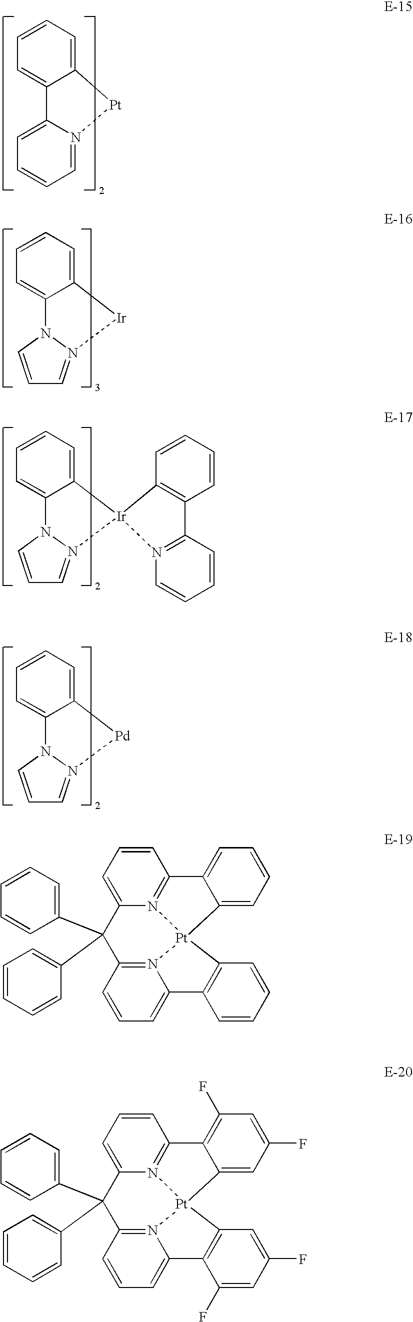

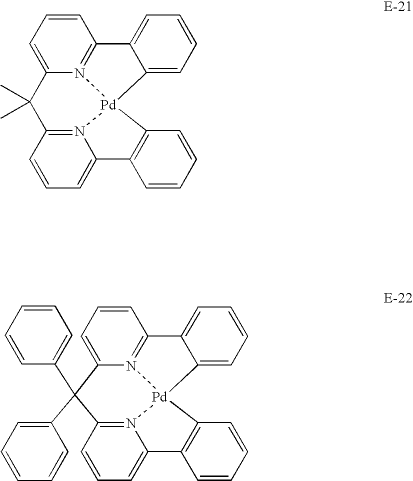

As the electron transporting host, E-1 to E-6, E-8, E-9, E-10, E-21, or E-22 is preferred, E-3, E-4, E-6, E-8, E-9, E-10, E-21, or E-22 is more preferred, and E-3, E-4, E-21, or E-22 is even more preferred.

In the light-emitting layer of the present invention, it is preferred that when a phosphorescent light-emitting dopant is used as the light-emitting dopant, the lowest triplet excitation energy T1(D) in the phosphorescent light-emitting dopant and the minimum value among the lowest triplet excitation energies T1(H)min in the host compound satisfy the relationship of T1(H)min>T1(D) in view of color purity, light-emission efficiency and drive durability.

Although a content of the host compound according to the present invention is not particularly limited, it is preferably from 15% by weight to 85% by weight with respect to the total mass of the compounds forming the light-emitting layer in view of light-emission efficiency and driving voltage.

A carrier mobility in the light-emitting layer is generally from 10⁻⁷ cm²·V⁻¹ to 10⁻¹ cm²·V⁻¹·s⁻¹, and within this range, it is preferably from 10⁻⁶ cm²·V^{31 1}·s⁻¹ to 10⁻¹ cm²·V⁻¹·s⁻¹, even more preferably, from 10⁻⁵ cm²·V⁻¹·s⁻¹ to 10⁻¹ cm²·V⁻¹·s⁻¹, and particularly preferably, from 10⁻⁴ cm²·V⁻¹·s⁻¹ to 10⁻¹ cm²·V⁻¹·s⁻¹ in view of light-emission efficiency.

It is preferred that the carrier mobility of the light-emitting layer is lower than that of the carrier transport layer, in view of light-emission efficiency and drive durability.

The carrier mobility is measured in accordance with the “Time of Flight” method, and the-resulting value is determined to be the carrier mobility.

### Hole-Blocking Layer

A hole-blocking layer is a layer having a function to prevent the holes transported from the anode to the light-emitting layer from passing through to the cathode side. According to the present invention, a hole-blocking layer may be provided as an organic compound layer adjacent to the light-emitting layer on the cathode side.

The hole-blocking layer is not particularly limited, but specifically, it may contain an aluminum complex such as aluminium (III) bis (2-methyl-8-quinolinato)-4-pnenylphenolate (BAlq), a triazole compound, a pyrazabol compound or the like.

It is preferred that a thickness of the hole-blocking layer is generally 50 nm or less in order to lower the driving voltage, more preferably from I nm to 50 nm, and even more preferably from 5 nm to 40 nm.

### Electrode

The anode and cathode in the present invention are either a mirror surface electrode having a high reflectance or a half transmitting and reflective electrode as described above, depending on which is the face from which the emitted light is extracted. Normally, the light is extracted from the anode face in the configuration of a so-called bottom-emission configuration, and from the cathode face in the configuration of a so-called top-emission configuration.

### 1) Anode

The anode may generally have a function as an electrode for supplying holes to the organic compound layer.

Materials for the anode may preferably include, for example, metals, alloys, metal oxides, electrically conductive compounds, and mixtures thereof, and those having a work function of 4.0 eV or more are preferred. Specific examples of the anode materials include electrically conductive metal oxides such as tin oxides doped with antimony, fluorine or the like (ATO and FTO), tin oxide, zinc oxide, indium oxide, indium tin oxide (ITO), and indium zinc oxide (IZO); metals such as gold, silver, chromium, and nickel; mixtures or laminates of these metals and the electrically conductive metal oxides; inorganic electrically conductive materials such as copper iodide and copper sulfide; organic electrically conductive materials such as polyaniline, polythiophene, and polypyrrole; and laminates of these inorganic or organic electron-conductive materials with ITO. Among these, the electrically conductive metal oxides are preferred, and particularly, ITO is preferable in view of productivity, high electric conductivity, transparency and the like.

The anode may be formed on the substrate in accordance with a method which is appropriately selected from among wet methods such as printing methods, coating methods and the like; physical methods such as vacuum deposition methods, sputtering methods, ionplating methods and the like; and chemical methods such as chemical vapor deposition (CVD) and plasma CVD methods and the like, in consideration of the suitability to a material which forms the anode. For instance, when ITO is selected as a material for the anode, the anode may be formed in accordance with a DC or high-frequency sputtering method, a vacuum deposition method, an ionplating method or the like.

In the organic EL part employed in the present invention, a position at which the anode is to be formed is not particularly limited, and it may be suitably selected according to the application and purpose of the light-emitting element. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, or a lift-off method or a printing method may be applied.

A thickness of the anode may be suitably selected according to the material which forms the anode and is therefore not definitely decided, but it is usually in a range of about 10 nm to about 50 μm, and preferably from 50 nm to 20 μm.

A value of electric resistance of the anode is preferably 10³ Ω/□ or less, and more preferably 10² Ω/□ or less.

### 2) Cathode

The cathode generally has a function as an electrode for injecting electrons to the organic compound layer.

Materials which form the cathode may include, for example, metals, alloys, metal oxides, electrically conductive compounds, and mixtures thereof, and materials having a work function of 4.5 eV or less are preferred. Specific examples thereof include alkali metals (e.g., Li, Na, K, Cs or the like), alkaline earth metals (e.g., Mg, Ca or the like), gold, silver, lead, aluminum, sodium-potassium alloys, lithium-aluminum alloys, magnesium-silver alloys, rare earth metals such as indium, and ytterbium, and the like. They may be used alone, but it is preferred that two or more of them are used in combination from the viewpoint of satisfying both stability and electron injectability.

Among these, as the materials which form the cathode, alkaline metals or alkaline earth metals are preferred in view of electron injectability, and materials containing aluminum as a major component are preferred in view of excellent preservation stability.

The term “material containing aluminum as a major component” refers to a material formed of aluminum alone; alloys containing aluminum and 0.01% by weight to 10% by weight of an alkaline metal or an alkaline earth metal; or the mixtures thereof (e.g., lithium-aluminum alloys, magnesium-aluminum alloys and the like).

Regarding materials for the cathode, they are described in detail in JP-A Nos. 2-15595 and 5-121172, of which are incorporated by reference herein.

A method for forming the cathode is not particularly limited, and it may be formed in accordance with a well-known method.

For instance, the cathode may be formed in accordance with a method which is appropriately selected from among wet methods such as printing methods, coating methods and the like; physical methods such as vacuum deposition methods, sputtering methods, ionplating methods and the like; and chemical methods such as CVD and plasma CVD methods and the like, in consideration of the suitability to a material which form the cathode. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, or a lift-off method or a printing method may be applied.

In the present invention, a position at which the cathode is to be formed is not particularly limited, and it may be formed on either the whole or a part of the organic compound layer.

Furthermore, a dielectric material layer made of fluorides, oxides or the like of an alkaline metal or an alkaline earth metal may be inserted between the cathode and the organic compound layer with a thickness of 0.1 nm to 5 nm. The dielectric layer may be considered to be a kind of electron injection layer. The dielectric material layer may be formed in accordance with, for example, a vacuum deposition method, a sputtering method, an ion-plating method or the like.

A thickness of the cathode may be suitably selected according to materials which form the cathode and is therefore not definitely decided, but it is usually in a range of about 10 nm to about 5 μm, and preferably from 50 nm to 1 μm.

### Substrate

According to the present invention, a substrate may be applied. The substrate to be applied is preferably one which does not scatter or attenuate light emitted from the organic compound layer. Specific examples of materials for the substrate include inorganic materials such as zirconia-stabilized yttrium (YSZ) and glass; polyesters such as polyethylene terephthalate, polybutylene phthalate, and polyethylene naphthalate; and organic materials such as polystyrene, polycarbonate, polyethersulfon, polyarylate, polyimide, polycycloolefin, norbornene resin, polychlorotrifluoroethylene, and the like.

For instance, when glass is used as the substrate, non-alkali glass is preferably used with respect to the quality of material in order to decrease ions eluted from the glass. In the case of employing soda-lime glass, it is preferred to use glass on which a barrier coat such as silica has been applied. In the case of employing an organic material, it is preferred to use a material excellent in heat resistance, dimension stability, solvent resistance, electric, insulation performance, and workability.

There is no particular limitation as to the shape, the structure, the size or the like of the substrate, but it may be suitably selected according to the application, purpose and the like of the light-emitting element. In general, a plate-like substrate is preferred as to the shape of the substrate. A structure of the substrate may be a monolayer structure or a laminated structure. Furthermore, the substrate may be formed from a single member or two or more members.

Although the substrate may be transparent and colorless, or transparent and colored, it is preferred that the substrate is transparent and colorless from the viewpoint that the substrate does not scatter or attenuate light emitted from the organic light-emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

### Protective Layer

According to the present invention, the whole organic EL element may be protected by a protective layer.

A material contained in the protective layer may be one having a function to prevent penetration of substances such as moisture and oxygen, which accelerate deterioration of the element, into the element.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNe, SiN_{y}O_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ionplating method, a plasma polymerization method (high-frequency excitation ionplating method), a plasma CVD method, a laser CVD method, a thermal CVD method, a gas source CVD method, a coating method, a printing method, or a transfer method may be applied.

### Sealing

The entire of the light-emitting element of the present invention may be sealed with a sealing cap.

Furthermore, a moisture absorbent or an inert liquid may be used to seal a space defined between the sealing cap and the light-emitting element. The moisture absorbent is not particularly limited. Specific examples thereof include barium oxide, sodium oxide, potassium oxide, calcium oxide, sodium sulfate, calcium sulfate, magnesium sulfate, phosphorus pentaoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorocarbon solvents such as perfluoroalkanes, perfluoroamines, perfluoroethers and the like; chlorine-based solvents; silicone oils; and the like.

In the light-emitting element of the present invention, when a DC (AC components may be contained as needed) voltage (usually 2 volts to 40 volts) or DC is applied between the anode and the cathode, light emission can be obtained.

For the driving method of the light-emitting element according to the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

### Application of Light-Emitting Element of the Invention

The light-emitting element of the present invention can be appropriately used for indicating elements, displays, signages, advertising displays, interior accessories and the like.

All publications, patent applications, and technical standards mentioned in this specification are herein incorporated by reference to the same extent as if each individual publication, patent application, or technical standard was specifically and individually indicated to be incorporated by reference.

### EXAMPLES

Hereinafter, Examples of the light-emitting element of the invention is to be described, but the invention is not limited to these Examples. In the following Examples, as the most preferable manufacturing method, the thickness of an insulating layer adjacent to an organic electroluminescent part or a color changing layer, the thickness of a transparent electrode, and the like are fixed. When manufactured by changing the thicknesses, an increase in the number of production processes cannot be avoided, but the object of obtaining high color purity by a color changing method is achieved. Thus, such a case is within the scope of the invention.

### Resonance Distance

When an Al film having a thickness of 100 nm is used as a light reflection layer, and a silver thin film having a thickness of 25 nm is used a layer that partially transmits light and partially reflects light, a resonating optical path length is estimated for each color as follows.

In order to intensify light having a wavelength X, the optical path length d may be adjusted so that m in the following Equality (1) is an integer. In the equality, n is a refractive index of a layer through which light passes, and 4 is a phase shift amount of light in the light reflection layer. When a plurality of layers having a refractive index different from each other are laminated, and the refractive index and thickness of each layer are represented by (n1, d1), (n2, d2), . . . , the 2nd portion may be represented by 2(n1*d1+n2*d2+ . . . ).

2nd/λ+φ/2π=m Equality (1):

When φ in Equality (1) is determined by experiment, and the optical path length (the distance between a layer that partially transmits light and partially reflects light and a light reflection layer, in terms of organic layer) intensifying 460 nm, 520 nm, and 620 nm, the following results are obtained. When a green element with high color purity is created using a blue EL element and a green changing layer in combination, an optical path length intensifying a green color and not intensifying a blue color may be selected. Similarly, when a red element with high color purity is created using a blue element and a red changing layer, an optical path length intensifying a red color and not intensifying a blue color may be selected.

Optical path length resonating a blue color (460 nm): 203 nm±135 nm (namely, 203 nm, 338 nm, 473 nm, and so on) Optical path length resonating a green color (520 nm): 242 nm±153 nm (namely, 242 nm, 395 nm, 548 nm, and so on) Optical path length resonating a red color (620 nm): 308 nm±182 nm (namely, 126 nm, 308 nm, 490 nm, and so on)

Preparation of Substrate Having Layer that Partially Transmits Light and Partially Reflects Light

A polycarbonate substrate having a thickness of 0.7 mm was subjected to ultrasonic cleaning in 2-propanol, and then subjected to UV-ozone treatment for 20 minutes. On the treated surface, the following layer that partially transmits light and partially reflects light was formed by vacuum deposition.
Layer that partially transmits light and partially reflects light: silver was vapor-deposited to have a thickness of 25 nm.

### Preparation of Blue Light-Emitting Element

A blue light-emitting element was prepared.

On the layer that partially transmits light and partially reflects light, the following electrodes and organic layer were successively vapor-deposited, and thereby a blue light emitting organic EL part having the following structure was formed.

### Element Structure

ITO (50 nm)/Organic layer (144 nm)/LiF (0.5 nm)/Al (100 nm)

Structure of the blue light emitting organic layer: (2-TNATA+0.1% by weight of F4-TCNQ) (64 nm))/(NPD (10 nm)/mCP+15% by weight of Pt-1) (30 nm)/BAlq (40 nm)

The resonance distance of the element is 203 nm in terms of ITO(50*2.0/1.7)+organic layer (144 nm). This value is in agreement with the optical path length intensifying light having a wavelength of 460 nm as described above.

The light emission peak wavelength of the obtained element was 460 nm.

### Example 1

A green light-emitting element was prepared.

On the layer that partially transmits light and partially reflects light, the following electrodes and organic layer were successively vapor-deposited, and thereby a green light emitting organic EL part having the following structure was formed. The organic layer has the same structure as that of the blue light-emitting element. The mCP layers disposed in such a manner as to sandwich the color changing layer therebetween are disposed so as to prevent the color changing material that has absorbed a blue light from being quenched by the metal layer (herein, the layer that partially transmits light and partially reflects light and the ITO electrode).

### Element Structure

mCP (10 nm)/Green color changing layer (19 nm)/mCP (10 nm)/ITO (50 nm)/Organic layer (144 nm)/LiF (0.5 nm)/Al (100 nm)

The green color changing layer has the following composition, and emits a green light having a wavelength of 520 nm.

Green color changing layer composition: t(npa)py and t(dta)py were co-deposited so that the amount of t(dta)py would be 1% by weight with respect to the amount of t(npa)py. The thickness was 19 nm.

The optical path length of the structure described above is 242 nm in terms of mCP (10 nm)+Green changing layer (19 nm)+mCP (10 nm)+ITO (50*2.0/1.7)+Organic layer (144 nm). This value is in agreement with the optical path length intensifying light having a wavelength of 520 nm, and is not in agreement with the optical path length intensifying a blue color light as described above.

### Example 2

A red light-emitting element was prepared.

On the layer that partially transmits light and partially reflects light, the following electrodes and organic layer were successively vapor-deposited, and thereby a red light emission organic EL part having the following structure was formed. The organic layer has the same structure as that of the blue light-emitting element. The mCP layers disposed in such a manner as to sandwich the color changing layer therebetween are disposed so as to prevent the color changing material that has absorbed a blue light from being quenched by the metal layer (herein, the layer that partially transmits light and partially reflects light and the ITO electrode).

### Element Structure

mCP (10 nm)/Red color changing layer (85 nm)/mCP (10 nm)/ITO (50 nm)/Organic layer (144 nm)/LiF (0.5 nm)/Al (100 nm)

The red changing layer has the following composition, and emits a red light having a wavelength of 640 nm.

Red color changing layer composition: t(dta)py and DCJTB were co-deposited so that the amount of DCJTB would be 1% by weight with respect to the amount of t(dta)py. The thickness was 85 nm.

The optical path length of the structure described above is 308 nm in terms of mCP (10 nm)+Red changing layer (85 nm)+mCP (10 nm)+ITO (50*2.0/1.7)+Organic layer (144 nm). This value is in agreement with the optical path length intensifying light having a wavelength of 620 nm, and is not in agreement with the optical path length intensifying a blue color light as described above.

### Comparative Examples

A comparative green light-emitting element A and a comparative red light-emitting element B were prepared, wherein the arrangement of the color changing layer and the layer that partially transmits light and partially reflects light of each of the green light-emitting element and the red light-emitting element of Examples 1 and 2, respectively, was changed as described below.

### Element Structure

Comparative green light-emitting element A: Substrate/Green color changing layer (19 nm)/mCP (10 nm)/Layer that partially transmits light and partially reflects light (25 nm)/ITO (50 nm)/Organic layer (144 nm)/LiF (0.5 nm)/Al (100 nm)

The composition of the organic layers, and the composition of the green color changing layer were made the same as those of Example 1.

Comparative red-light-emitting element B: Substrate/Red color changing layer (85 nm)/mCP (10 nm)/Layer that partially transmits light and partially reflects light (25 nm)/ITO (50 nm)/Organic layer (144 nm)/LiF (1 nm)/Al (100 nm)

The composition of the organic layers and the composition of the red changing layer were made the same as those of Example 2.

The above-obtained elements of the invention and comparative elements were driven by a driving current of 0.4 mA (10 mA/cm²) using ITO as the anode and Al as the cathode. Then, the light-emission brightness and the spectrum of light taken out were measured with Brightness Meter CS-1000 manufactured by Konica Minolta Corp. The sharpness of emitted light was evaluated based on the spectral width (half wavelength width) at ½ intensity of the peak photon numbers at the maximum light-emission wavelength. The smaller the half wavelength width is, the sharper the spectrum is. Table 1 shows the maximum light emission wavelength, peak photon numbers (relative value), and half wavelength width.

As a result, the elements of Examples 1 and 2 according to the invention emits light with high color purity having a larger peak photon numbers at the maximum light-emission wavelength, and an extremely small half wavelength width, as compared with the comparative elements A and B. Moreover, the leakage of a 460 nm blue color light that was not absorbed in the color changing layer was observed in the comparative elements. In contrast, in the elements of Examples 1 and 2 according to the invention, the leakage of a blue color light was not observed in spite of the same thickness of the color changing layer, and light emission with high color purity was observed.

TABLE 1

| | Light-emission | Half | Peak |
|---|---|---|---|
| | wavelength | wavelength | photon |
| | (nm) | width (nm) | number |
| Blue light emitting | 460 | 25 | 1.0 |
| element | | | |
| Comparative element A | 460 | 25 | 0.6 |
| | 520 | 60 | 0.3 |
| Comparative element B | 460 | 25 | 0.6 |
| | 640 | 80 | 0.2 |
| Example 1 | 460 | No emission | 0.0 |
| | 520 | 25 | 0.9 |
| Example 2 | 460 | No emission | 0.0 |
| | 620 | 30 | 0.3 |

Chemical structures of the compounds used in Examples are shown below.

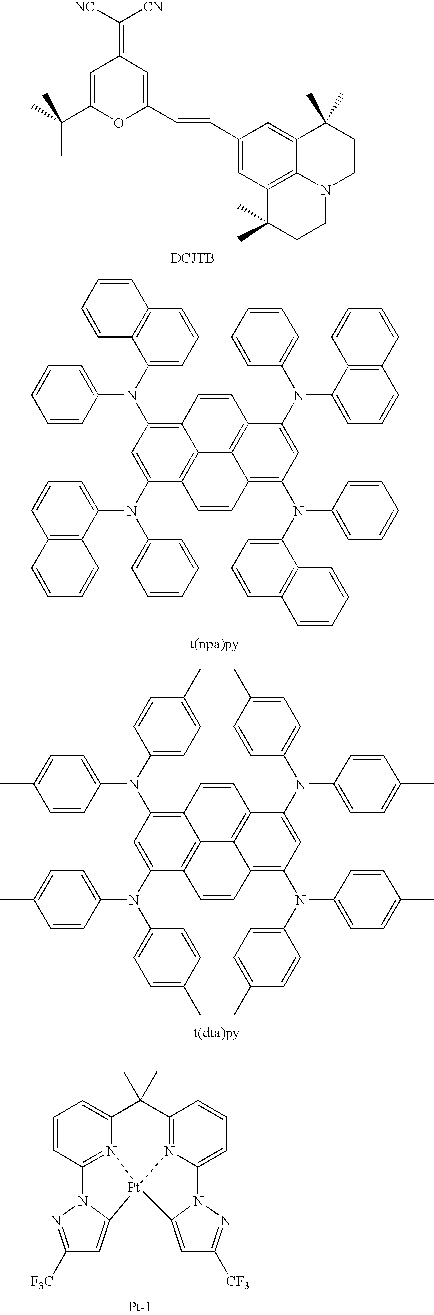

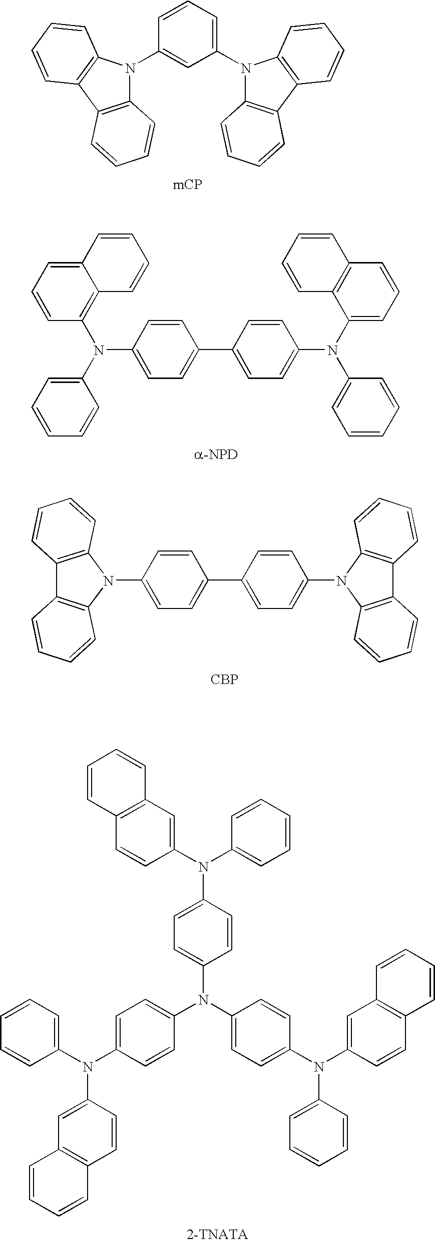

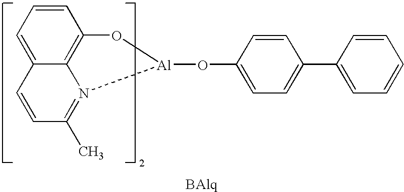

What is claimed is:

1. A light-emitting element comprising, on a substrate:
an organic electroluminescent part having at least one organic layer including a light-emitting layer between a pair of electrodes; and
a color changing layer that absorbs light emitted from the organic electroluminescent part, and emits light having a wavelength different from that of the absorbed light;
wherein the organic electroluminescent part and the color changing layer are disposed in a microcavity structure interposed between a light reflection layer and a layer that partially transmits light and partially reflects light.

2. The light-emitting element according to claim 1, wherein at least one of the light reflection layer and the layer that partially transmits light and partially reflects light forming the microcavity structure is one of the electrodes.

3. The light-emitting element according to claim 1, wherein a light emission peak wavelength of the organic electroluminescent part is shorter than 500 nm.

4. The light-emitting element according to claim 1, wherein a wavelength of light intensified in the normal direction of the substrate surface due to the microcavity structure is a wavelength of the light emitted from the color changing layer.

5. The light-emitting element according to claim 1, wherein a light emitting material of the light-emitting layer comprises a phosphorescent light emitting material.

6. The light-emitting element according to claim 1, wherein the substrate is a flexible substrate.

7. The light-emitting element according to claim 1, wherein at least one of layers adjacent to the color changing layer is an insulating layer that does not absorb the light emitted from the organic electroluminescent part.

8. The light-emitting element according to claim 7, wherein a thickness of the insulating layer is from 5 nm to 30 nm.

9. A multicolor display comprising a plurality of arranged light-emitting elements, wherein at least one of the light-emitting elements is the light-emitting element according to claim 1.

10. The multicolor display according to claim 9, wherein:
the plurality of light-emitting elements are substantially similar to each other in terms of the light emission peak wavelength of the organic electroluminescent part; and
a resonance distance of the microcavity structure of the light-emitting element having the color changing layer is adjusted based on a thickness of the color changing layer, wherein the resonance distance is adjusted to a wavelength resonating the light which has been changed by the color changing layer.

11. The multicolor display according to claim 9, wherein a color filter is provided on the outside of the microcavity structure.

12. A method for manufacturing the light-emitting element according to claim 1, comprising:
forming a light-emitting layer;
forming a color changing layer; and
forming a pair of a light reflection layer and a layer that partially transmits light and partially reflects light between which both of the light-emitting layer and the color changing layer are interposed.
